(19) United States
(12) Patent Application Publication
(10) Pub. No.: US 2026/0346792 A1
(43) Pub. Date: Nov. 5, 2026

(54) CUSTOMIZABLE AND MODULAR CENTER CONSOLE ASSEMBLIES

(71) Applicant: Toyoda Gosei Co., Ltd., Kiosu-shi (JP)

(72) Inventors: Hideki Okigawa, Novi, MI (US); Roy C. Thorsell, Wixom, MI (US); Fran P. Camaj, Rochester Hills, MI (US)

(73) Assignee: Toyoda Gosei Co., Ltd., Kiosu-shi (JP)

(21) Appl. No.: 19/077,555

(22) Filed: Mar. 12, 2025

(51) Int. Cl. B60R 7/04

(52) U.S. Cl. CPC B60R 7/04

(57) ABSTRACT

A center console assembly includes a base unit including a base register, and a storage unit including a rear end assembly, the rear end assembly including an upper register, the rear end assembly mounted to the base register to removably attach the storage unit to the base unit. In embodiments, the rear end assembly includes a rear end duct having an inlet and an outlet opposite the inlet. The inlet of the rear end duct abuts against the base register and directs a flow of air from the base register to the outlet of the upper register.

### TECHNICAL FIELD

The present specification generally relates to customizable center consoles for vehicles and, more specifically, center consoles having modular components allowing for various configurations and features.

### BACKGROUND

Vehicle center consoles have evolved significantly over the past several decades, transitioning from simple storage compartments to multifunctional hubs that integrate advanced technology and convenience features. Traditionally, center consoles were designed as fixed structures with limited adaptability, housing basic storage spaces, cup holders, and occasionally climate controls or small electronic interfaces. Recent advancements have introduced more sophisticated designs, incorporating touchscreens, wireless charging pads, USB ports, and integrated controls for entertainment and navigation systems. However, these designs are often static, with little room for user customization or modularity to accommodate varying needs and preferences.

The growing diversity of vehicle users and their unique requirements has amplified the demand for customizable and modular center consoles. Drivers and passengers increasingly seek solutions that cater to specific lifestyle needs, such as enhanced storage for larger personal items, removable or reconfigurable compartments, and adaptable layouts for improved ergonomics. Additionally, as vehicles evolve into multifunctional spaces for work, leisure, and commuting, there is a rising interest in center consoles that can seamlessly transition between these roles. Despite some progress, most existing designs lack the flexibility to be tailored post-manufacture, limiting their utility across a wide range of use cases.

There remains an unmet need for innovative center console systems that offer both modularity and customization, enabling users to personalize their vehicle interiors. Such advancements could leverage modern materials, smart technologies, and innovative assembly techniques to create adaptable solutions that meet the dynamic demands of contemporary vehicle users. Addressing these challenges not only enhances user satisfaction but also aligns with broader trends in the automotive industry, such as the shift towards user-centric design and the integration of smart, connected components. Accordingly, a need exists for improved vehicle center consoles having modular and customizable capabilities.

### SUMMARY

In one embodiment, a center console assembly includes: a base unit including a base register; and a storage unit including a rear end assembly, the rear end assembly including an upper register, the rear end assembly mounted to the base register to removably attach the storage unit to the base unit.

In another embodiment, a center console assembly includes: a base unit including a base register; and a storage unit mounted to the base unit, the storage unit including a rear end assembly, the rear end assembly including a rear end duct having an inlet and an outlet opposite the inlet, and an upper register, wherein the inlet of the rear end duct abuts against the base register and directs a flow of air from the base register to the outlet of the upper register.

In yet another embodiment, a method includes: positioning a base unit on a floor pan of a vehicle, the base unit including a base register; securing the base unit to the floor pan; positioning a storage unit on the base unit, the storage unit including a rear end assembly, the rear end assembly including an upper register; and securing the storage unit to the base unit by engaging the rear end assembly with the base register.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side view of an embodiment of a center console assembly mounted to a floor pan of a vehicle, according to one or more embodiments shown and described herein;

FIG. 2 schematically depicts a rear perspective view of an embodiment of a base unit of the center console assembly of FIG. 1, according to one or more embodiments shown and described herein;

FIG. 3 schematically depicts an exploded rear perspective view of the base unit of FIG. 2, according to one or more embodiments shown and described herein;

FIG. 4 schematically depicts a front end view of the base unit of FIG. 2, according to one or more embodiments shown and described herein;

FIG. 5 schematically depicts a cross-sectional front end view of the base unit of FIG. 2 taken along line 5-5 of FIG. 2, according to one or more embodiments shown and described herein;

FIG. 6 schematically depicts a front perspective view of another embodiment of a base unit including an electrical connection assembly, according to one or more embodiments shown and described herein;

FIG. 7 schematically depicts an exploded rear perspective view of the electrical connection assembly of the base unit of FIG. 6, according to one or more embodiments shown and described herein;

FIG. 8 schematically depicts a rear perspective view of a storage unit of the center console assembly of FIG. 1, according to one or more embodiments shown and described herein;

FIG. 9 schematically depicts a bottom perspective view of the storage unit of FIG. 8, according to one or more embodiments shown and described herein;

FIG. 10 schematically depicts a top view of the storage unit of FIG. 8 with a lid removed, according to one or more embodiments shown and described herein;

FIG. 11 schematically depicts a top perspective view of a dial receiver formed in an interior of the storage unit of FIG. 8, according to one or more embodiments shown and described herein;

FIG. 12 schematically depicts a top perspective view of a dial positioned within the dial receiver of FIG. 11 and in an unlocked position, according to one or more embodiments shown and described herein;

FIG. 13 schematically depicts a bottom perspective view of the dial of FIG. 12 extending through a lower wall of the storage unit of FIG. 8 and in the unlocked position, according to one or more embodiments shown and described herein;

FIG. 14 schematically depicts a top perspective view of the dial positioned within the dial receiver of FIG. 11 and in a locked position, according to one or more embodiments shown and described herein;

FIG. 15 schematically depicts a bottom perspective view of the dial of FIG. 12 extending through the lower wall of the storage unit of FIG. 8 and in the locked position, according to one or more embodiments shown and described herein;

FIG. 16 schematically depicts an exploded front perspective view of a rear end assembly of the storage unit of FIG. 8, according to one or more embodiments shown and described herein;

FIG. 17 schematically depicts a cross-sectional side view of the storage unit of FIG. 8 taken along line 17-17 of FIG. 10, according to one or more embodiments shown and described herein;

FIG. 18 schematically depicts a rear perspective view of another embodiment of a storage unit, according to one or more embodiments shown and described herein;

FIG. 19 schematically depicts a partial cross-sectional side view of the storage unit of FIG. 18, according to one or more embodiments shown and described herein;

FIG. 20 schematically depicts a rear perspective view of a device holder of the center console assembly of FIG. 1, according to one or more embodiments shown and described herein;

FIG. 21 schematically depicts a rear perspective view of the base unit of FIG. 2 being assembled onto the floor pan, according to one or more embodiments shown and described herein;

FIG. 22 schematically depicts a rear perspective view of the storage unit of FIG. 8 being assembled onto the assembled base unit of FIG. 21, according to one or more embodiments shown and described herein;

FIG. 23 schematically depicts a cross-sectional side view of the center console assembly of FIG. 1 installed on the floor pan, according to one or more embodiments shown and described herein;

FIG. 24 schematically depicts an enlarged view of circle 24 taken from FIG. 23, according to one or more embodiments shown and described herein;

FIG. 25 schematically depicts an enlarged view of circle 25 taken from FIG. 23, according to one or more embodiments shown and described herein;

FIG. 26 schematically depicts an enlarged view of circle 26 taken from FIG. 23, according to one or more embodiments shown and described herein;

FIG. 27 schematically depicts a side view of the device holder of FIG. 20 being installed onto the storage unit of the center console assembly of FIG. 1, according to one or more embodiments shown and described herein;

FIG. 28 schematically depicts a partial rear perspective view of the center console assembly of FIG. 1 including an accessory mounting plate and a tablet station mounted to a rear end of the storage unit, according to one or more embodiments shown and described herein;

FIG. 29 schematically depicts a partial rear perspective view of the center console assembly of FIG. 1 including the accessory mounting plate of FIG. 28 mounted to the rear end of the storage unit, according to one or more embodiments shown and described herein; and

FIG. 30 schematically depicts a rear perspective view of the tablet station of FIG. 28, according to one or more embodiments shown and described herein; and

FIG. 31 schematically depicts a front perspective view of the tablet station of FIG. 28, according to one or more embodiments shown and described herein; and

FIG. 32 schematically depicts a partial rear perspective view of the center console assembly of FIG. 1 including the accessory mounting plate of FIG. 28 and a cooler mounted to the rear end of the storage unit, according to one or more embodiments shown and described herein.

### DETAILED DESCRIPTION

Embodiments described herein are directed to center console assemblies that includes modular base units and storage units that may be coupled to one another. A center console assembly includes a base unit including a base register, and a storage unit including a rear end assembly, the rear end assembly including an upper register, the rear end assembly mounted to the base register to removably attach the storage unit to the base unit. In embodiments, the rear end assembly includes a rear end duct having an inlet and an outlet opposite the inlet. The inlet of the rear end duct abuts against the base register and directs a flow of air from the base register to the outlet of the upper register. Various embodiments of the center console assemblies and the operation of the center console assemblies are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components, unless the context clearly indicates otherwise.

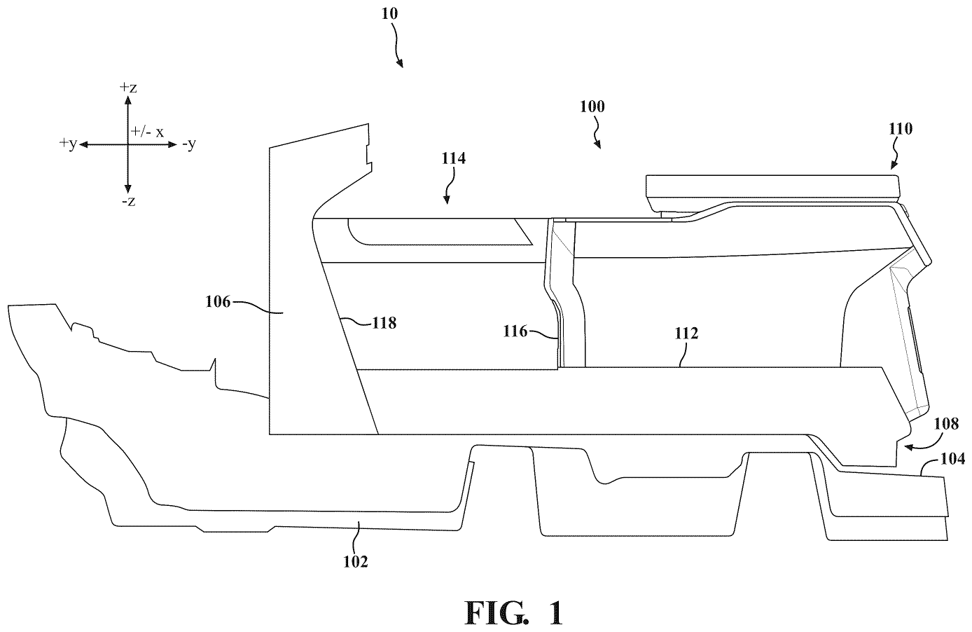

As used herein, the term “longitudinal direction” refers to the forward-rearward direction (i.e., in the +/−Y direction depicted in FIG. 1). The term “lateral direction” refers to the cross direction (i.e., in the +/−X direction depicted in FIG. 1), and is transverse to the longitudinal direction. The term “vertical direction” refers to the upward-downward direction (i.e., in the +/−Z direction depicted in FIG. 1). As used herein, “upper” and “above” are defined as the positive Z direction of the coordinate axes shown in the drawings. “Lower” and “below” are defined as the negative Z direction of the coordinate axes shown in the drawings.

Directional terms as used herein—for example up, down, right, left, front, back, top, bottom-are made only with reference to the figures as drawn and are not intended to imply absolute orientation.

Referring now to FIG. 1, an embodiment of a center console assembly 100 is illustrated according to one or more embodiments described herein. As shown, the center console assembly 100 is mounted on a floor pan 102 of a vehicle 10. The floor pan 102 includes an upper surface 104. In embodiments, an upstanding support member 106 is mounted to the upper surface 104 of the floor pan 102 forward in the longitudinal direction relative to the center console assembly 100. Although referred to herein as the floor pan 102, it should be appreciated that the center console assembly 100 may be mounted to any suitable portion of a chassis of the vehicle 10 such as, for example, a floorboard, transmission tunnel, or the like.

Additionally, the center console assembly 100 may be part of any suitable vehicle such as, for example an automobile which includes coupes, sedans, minivans, trucks, crossovers, hybrids, and sports utility vehicles. However, the center console assembly 100 is not limited to being incorporated in such automobiles. In embodiments, the center console assembly 100 may be provided in any vehicle such as a watercraft, aircraft, or the like.

The center console assembly 100 may generally include a base unit 108 mounted directly onto the upper surface 104 of the floor pan 102, and a storage unit 110 mounted onto an upper surface 112 of the base unit 108 opposite the floor pan 102. In embodiments, as described in more detail herein, a device holder 114 may be mounted to the center console assembly 100 between a front end 116 of the storage unit 110 and a rear surface 118 of the upstanding support member 106.

As used herein, the term “front” or “front-facing” and “rear” or “rear-facing” may refer to a similar orientation to that of the vehicle in which the center console assembly is installed. For example, a “front” or “front-facing” surface may refer to a surface facing a +Y direction of the vehicle, and a “rear” or “rear-facing” surface may refer to a surface facing a −Y direction of the vehicle.

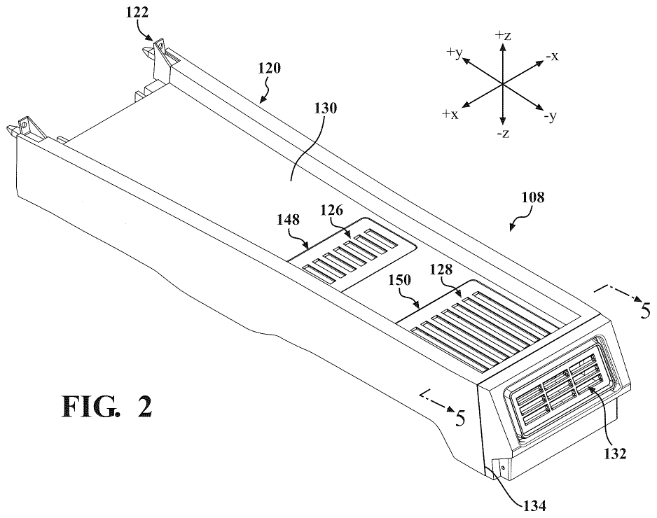

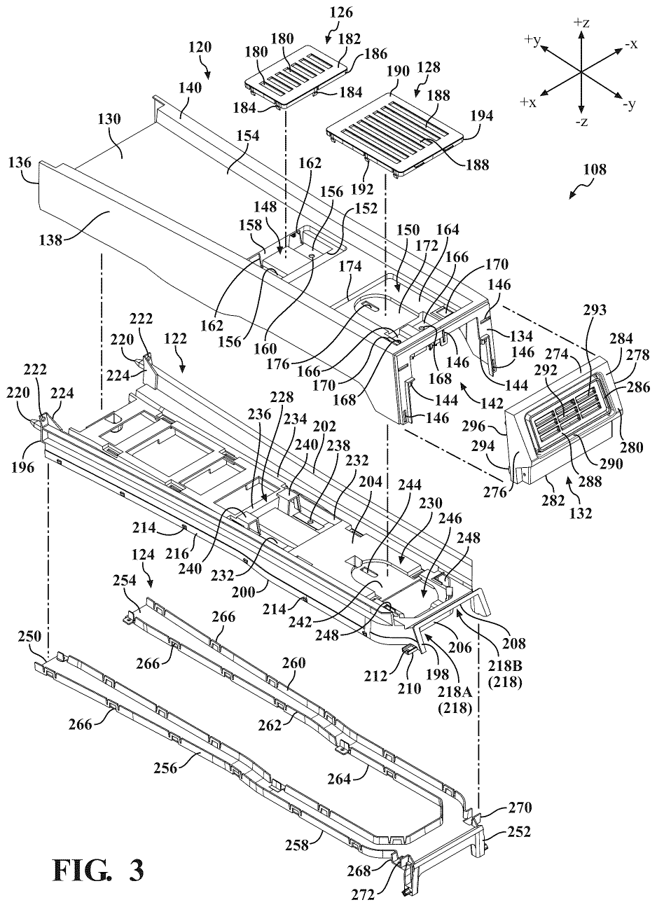

Referring now to FIGS. 2 and 3, the base unit 108 is depicted. The base unit 108 includes a base housing 120, an upper guide member 122 (FIG. 3) received within the base housing 120, a lower guide member 124 (FIG. 3) received within the base housing 120, a front recess cover 126 and a rear recess cover 128 provided on an upper wall 130 of the base housing 120, and a base register 132 provided on a rear end 134 of the base housing 120.

With reference now to FIG. 3, an exploded view of the base unit 108 is depicted to better illustrate each of the individual components of the base unit 108. The base housing 120 includes a front end 136, the rear end 134 opposite the front end 136, a first side wall 138 extending between the front end 136 and the rear end 134, a second side wall 140 opposite the first side wall 138 extending between the front end 136 and the rear end 134, and the upper wall 130 extending between the first side wall 138 and the second side wall 140. The first side wall 138, the second side wall 140, and the upper wall 130 define an open interior 142 of the base housing 120 in which the upper guide member 122 and the lower guide member 124 are positioned.

In embodiments, a pair of pins 144 extend along the rear end 134 of the base housing 120 in a direction opposite the upper wall 130. Additionally, in embodiments, a plurality of channels 146 are formed in the rear end 134 of the base housing 120 along the first side wall 138, the second side wall 140, and/or the upper wall 130. As shown, a pair of channels 146 are formed on the first side wall 138, a pair of channels 146 are formed on the second side wall 140, and one channel 146 is formed on the upper wall 130.

In embodiments, the upper wall 130 of the base housing 120 defines a front recessed portion 148 and a rear recessed portion 150 spaced apart from the front recessed portion 148 along the Y axis. The front recessed portion 148 and the rear recessed portion 150 are recessed into the open interior 142 of the base housing 120. The front recessed portion 148 includes a recessed wall 152 recessed a first distance from an upper surface 154 of the upper wall 130 of the base housing 120, and a pair of depression walls 156 recessed a second distance from the recessed wall 152. In embodiments, the second distance is greater than the first distance. However, it should be appreciated that, the second distance may be either equal to or less than the first distance. A front wall 158 extends from the depression walls 156 to the upper surface 154 of the upper wall 130 of the base housing 120. A hole 160 is formed in each of the depression walls 156 for receiving a fastener. A pair of receiving openings 162 are formed in the front wall 158 and are each aligned with a respective depression wall 156.

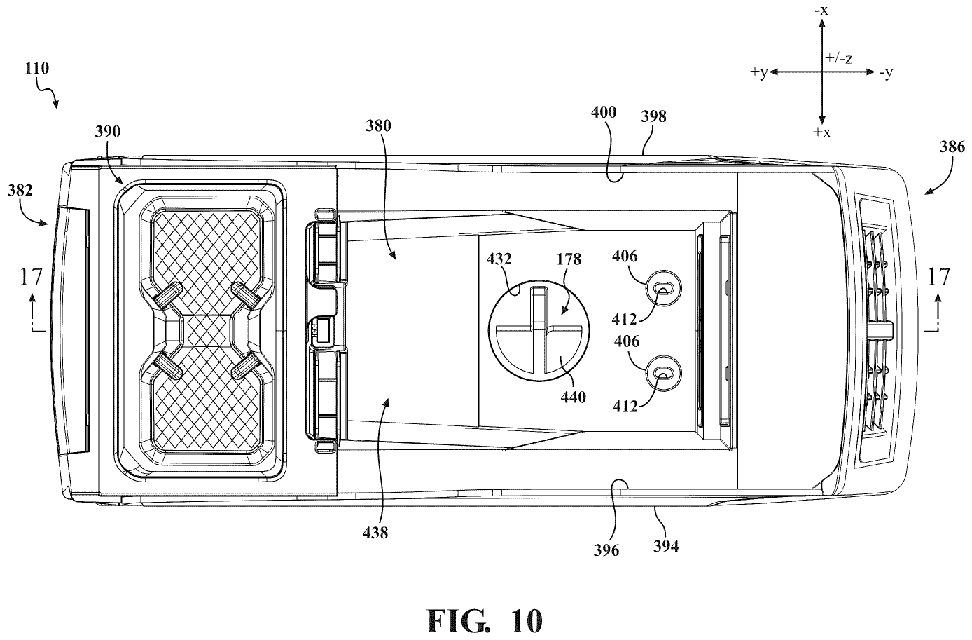

In embodiments, the rear recessed portion 150 includes a recessed wall 164 recessed a first distance from the upper surface 154 of the upper wall 130 of the base housing 120, and a pair of depression walls 166 recessed a second distance from the recessed wall 164. In embodiments, the second distance is greater than the first distance. However, it should be appreciated that, the second distance may be either equal to or less than the first distance. A hole 168 is formed in each of the depression walls 166 for receiving a fastener. A pair of receiving openings 170 are formed in the recessed wall 164 on outer sides of the depression walls 166. In embodiments, an engagement wall 172 is recessed from the recessed wall 164 and formed between the depression walls 166 and a front edge 174 of the recessed wall 164. As shown, the engagement wall 172 has at least a partially circular perimeter. However, it should be appreciated that the perimeter of the engagement wall 172 may have any suitable shape. A slot 176 is formed in the engagement wall 172. As described in more detail herein, the slot 176 may be utilized to receive a dial 178 of the storage unit 110 (FIG. 10) to temporarily couple the base housing 120 and the storage unit 110 to one another.

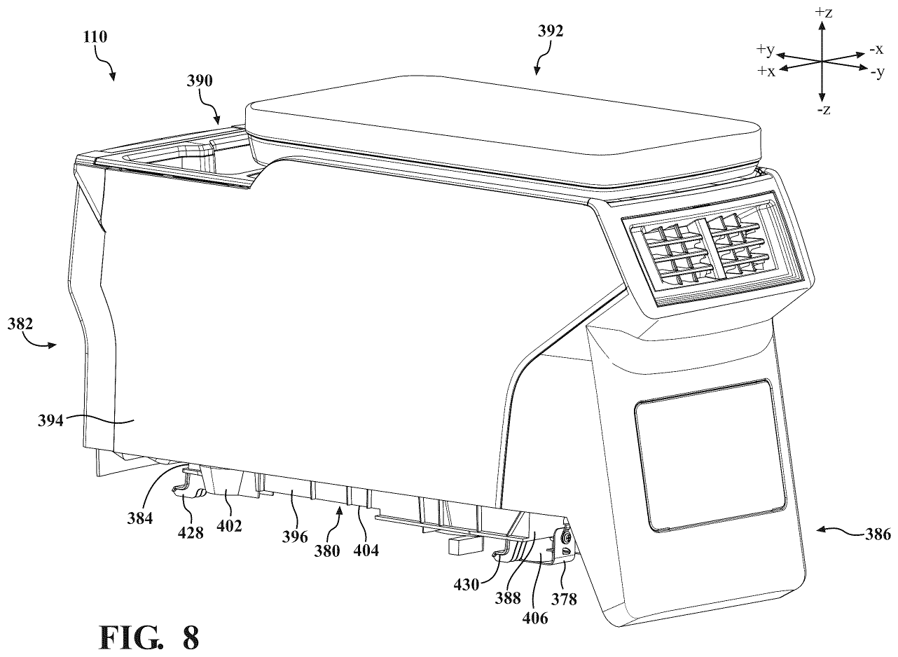

As described in more detail herein, the base unit 108 may be utilized as a standalone component without being coupled to the storage unit 110 (FIG. 8). As a standalone component, the base unit 108 is not utilized to provide power to external mobile devices. In such situations, the front recess cover 126 is provided on the recessed wall 152 of the front recessed portion 148, and the rear recess cover 128 is provided on the recessed wall 164 of the rear recessed portion 150, as shown in FIG. 2. As shown in FIG. 3, the front recess cover 126 includes a plurality of recessed ribs 180 formed in an upper surface 182 of the front recess cover 126 to improve rigidity. Additionally, the front recess cover 126 includes one or more latches 184 extending from an outer perimeter wall 186 to engage the front recessed portion 148 when the front recess cover 126 is lowered onto the recessed wall 152 of the front recessed portion 148. Similarly, the rear recess cover 128 includes a plurality of recessed ribs 188 formed in an upper surface 190 of the rear recess cover 128 to improve rigidity. Additionally, the rear recess cover 128 includes one or more latches 192 extending from an outer perimeter wall 194 to engage the rear recessed portion 150 when the rear recess cover 128 is lowered onto the recessed wall 164 of the rear recessed portion 150. In other embodiments, a single recess cover may be utilized to cover both the front recessed portion 148 and the rear recessed portion 150.

Referring still to FIG. 3, the upper guide member 122 includes a front end 196, a rear end 198 opposite the front end 196, a first side wall 200 extending between the front end 196 and the rear end 198, a second side wall 202 opposite the first side wall 200 extending between the front end 196 and the rear end 198, an upper wall 204 extending between the first side wall 200 and the second side wall 202, and a guide wall 206 extending from a lower surface 208 of the upper wall 204 proximate the rear end 198 to the front end 196.

In embodiments, one or more flanges 210 extend from the rear end 198 of the upper guide member 122 and a hole 212 is formed in the flange 210. As shown in FIG. 3, a flange 210 is shown extending from the first side wall 200. However, it should be appreciated that a flange 210 may similarly extend from the second side wall 202.

In embodiments, a plurality of hooks 214 are formed on an outer surface 216 of the first side wall 200 and the second side wall 202. Although the hooks 214 are only shown on the outer surface 216 of the first side wall 200, it should be appreciated that similar hooks 214 may also be formed on an outer surface of the second side wall 202. In embodiments, the hooks 214 are equidistantly spaced apart from one another.

The first side wall 200, the second side wall 202, the guide wall 206, and a portion of the upper wall 204 between the guide wall 206 and the first and second side walls 200, 202 cooperate to partially define a flow path 218. The flow path 218 extends from the front end 196 of the upper guide member 122 and terminates at the rear end 198 of the upper guide member 122. The flow path 218 includes a first flow path channel 218A between the guide wall 206 and the first side wall 200, and a second flow path channel 218B between the guide wall 206 and the second side wall 202. As described in more detail herein, air is directed from the front end 196 of the upper guide member 122 and along the first flow path channel 218A and the second flow path channel 218B to the rear end 198 of the upper guide member 122.

In embodiments, a pair of pins 220 extend from the first side wall 200 and the second side wall 202 at the front end 196 in a direction opposite the rear end 198. Additionally, in embodiments, a pair of holes 222 are formed in flanges 224 provided on the first side wall 200 and the second side wall 202 at the front end 196. The pins 220 and the holes 222 may be utilized to couple the upper guide member 122 to the floor pan 102 (FIG. 1) such as by engaging the pins 220 with respective flanges 226 formed in the upstanding support member 106 and extending a fastener through each of the holes 222 and into the flanges 226 of the upstanding support member 106.

In embodiments, the upper wall 204 of the upper guide member 122 defines a front recessed portion 228 and a rear recessed portion 230 spaced apart from the front recessed portion 228 along the Y axis. The front recessed portion 228 and the rear recessed portion 230 are recessed in the same direction of the guide wall 206. The front recessed portion 228 includes a pair of depression walls 232 recessed from an upper surface 234 of the upper wall 204 of the upper guide member 122. A front wall 236 extends from the depression walls 232 to the upper surface 234 of the upper wall 204 of the upper guide member 122. A hole 238 is formed in each of the depression walls 232 for receiving a fastener. A pair of tunnels 240 are formed in the front wall 236 and are each aligned with a respective depression wall 232.

In embodiments, the rear recessed portion 230 includes an engagement wall 242 recessed from the upper surface 234 of the upper wall 204. As shown, the engagement wall 242 has at least a partially circular perimeter. However, it should be appreciated that the perimeter of the engagement wall 242 may have any suitable shape. A slot 244 is formed in the engagement wall 242. A void 246 is formed between the engagement wall 242 and the rear end 198 of the upper guide member 122. A pair of receiving openings 248 are formed on opposite sides of the void 246.

With the base housing 120 installed on the upper guide member 122, the upper wall 130 of the base housing 120 is positioned on the upper wall 204 of the upper guide member 122 such that the pins 144 provided on the rear end 134 of the base housing 120 are received within the holes 212 formed in the flanges 210 at the rear end 198 of the upper guide member 122. The front recessed portion 148 and the rear recessed portion 150 of the base housing 120 are received within the front recessed portion 228 and the rear recessed portion 230 of the upper guide member 122, respectively. A location of the receiving openings 248 formed in the upper guide member 122 corresponds to a location of the receiving openings 170 formed in the base housing 120. Additionally, a location of the slot 244 formed in the engagement wall 242 of the upper guide member 122 corresponds with a location of the slot 176 formed in the engagement wall 172 of the base housing 120 such that each slot 244, 176 receives the dial 178 of the storage unit 110 (FIG. 10) to releasably couple the upper guide member 122 and the storage unit 110 to one another.

Referring still to FIG. 3, the lower guide member 124 includes a front end 250, a rear end 252 opposite the front end 250, a lower wall 254 extending between the front end 250 and the rear end 252, a first side wall 256 extending along an outer edge 258 of the lower wall 254 between the front end 250 and the rear end 252, a second side wall 260 opposite the first side wall 256 extending along the outer edge 258 of the lower wall 254 between the front end 250 and the rear end 252, and a guide wall 262 extending along an inner edge 264 of the lower wall 254 to the front end 250. A plurality of clips 266 are provided along the first side wall 256, the second side wall 260, and the guide wall 262. Additionally, a first bracket 268 extends from the first side wall 256 proximate the rear end 252 of the lower guide member 124 in a direction opposite the second side wall 260, and a second bracket 270 extends from the second side wall 260 proximate the rear end 252 of the lower guide member 124 in a direction opposite the first side wall 256. The first bracket 268 and the second bracket 270 each have a U-shape. However, the first bracket 268 and the second bracket 270 may have any suitable shape. A hole 272 is formed in each of the first bracket 268 and the second bracket 270.

With the lower guide member 124 positioned on the upper guide member 122, the flanges 210 extending from the first side wall 200 and the second side wall 202 of the upper guide member 122 are received within a respective one of the first bracket 268 and the second bracket 270 of the lower guide member 124. The clips 266 provided on the first side wall 256 and the second side wall 260 of the lower guide member 124 engage the hooks 214 formed on the first side wall 200 and the second side wall 202 of the upper guide member 122. Additionally, the clips 266 formed on the guide wall 262 of the lower guide member 124 may engage corresponding hooks 214 formed on the upper guide member 122 not illustrated herein. It should be appreciated that any suitable fastening mechanisms may be utilized to couple the lower guide member 124 to the upper guide member 122 other than that depicted herein.

Additionally, with the lower guide member 124 installed on the upper guide member 122, the lower wall 254 of the lower guide member 124 cooperates with the upper guide member 122 to further define the first flow path channel 218A and the second flow path channel 218B of the flow path 218. Accordingly, air is directed from the front end 250 of the lower guide member 124 and along the first flow path channel 218A and the second flow path channel 218B to the rear end 252 of the lower guide member 124.

Referring still to FIG. 3, the base register 132 includes an upper surface 274, a first side wall 276 extending from the upper surface 274, a second side wall 278 opposite the first side wall 276 extending from the upper surface 274, a register wall 280 extending between the first side wall 276 and the second side wall 278 and from the upper surface 274 at an oblique angle relative to the first side wall 276 and the second side wall 278, and a lower wall 282 extending from the first side wall 276, the second side wall 278, and the register wall 280. The lower wall 282 is recessed inwardly to be dimensionally smaller than the other walls of the base register 132. The register wall 280 includes an outer register surface 284, a lip 286, and a contact surface 288. A groove 290 is recessed within the register wall 280 and formed between the outer register surface 284 and the lip 286. The groove 290 circumscribes the lip 286. The contact surface 288 is recessed relative to the lip 286.

As shown, the contact surface 288 provided on a side of the lip 286 opposite the outer register surface 284. The contact surface 288 includes a plurality of slots 292 arranged in columns and rows to permit air flowing through the flow path 218 to exit the upper guide member 122 and the lower guide member 124. The slots 292 may be arranged in any suitable configuration. Additionally, the slots 292 may have any suitable shape other than that depicted herein. In embodiments, the slots 292 are defined by fins 293. As shown in FIG. 3, the fins 293 are fixed. In other embodiments, the fins 294 are movable. In embodiments, a sealing member or gasket, not shown, is provided on the contact surface 288 of the base register 132 surrounding the slots 292 to form an airtight seal with the storage unit 110, as described in more detail herein.

In embodiments, a plurality of posts 294 extend from a front surface 296 of the base register 132 in a direction opposite the register wall 280. It should be appreciated the base register 132 may include any number of posts 294 such as posts 294 extending from the front surface 296 proximate the second side wall 278 and a central location substantially between the first side wall 276 and the second side wall 278 of the base register 132. With the base register 132 positioned on the rear end 134 of the base housing 120, the posts 294 are received within respective channels 146 formed in the rear end 134 of the base housing 120.

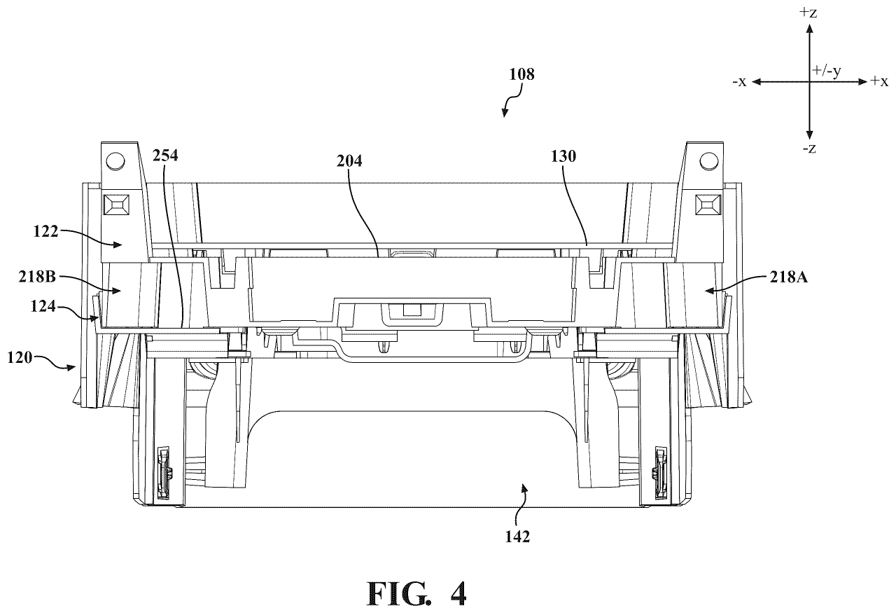

Referring now to FIG. 4, a front end view of the base unit 108 in an assembled state is depicted. As shown, the upper guide member 122 and the lower guide member 124 are at least partially received within the open interior 142 of the base housing 120. More particularly, the upper wall 130 of the base housing 120 is positioned on the upper wall 204 of the upper guide member 122, and the upper guide member 122 is positioned on the lower wall 254 of the lower guide member 124. Accordingly, the first flow path channel 218A and the second flow path channel 218B are partially defined by the first side wall 200, the second side wall 202, and the guide wall 206 of the upper guide member 122, and further defined by the lower wall 254 of the lower guide member 124. Accordingly, air is permitted to enter the first flow path channel 218A and the second flow path channel 218B at the front end 196 of the upper guide member 122 and be directed through the first flow path channel 218A and the second flow path channel 218B toward the rear end 198 (FIG. 3) of the upper guide member 122.

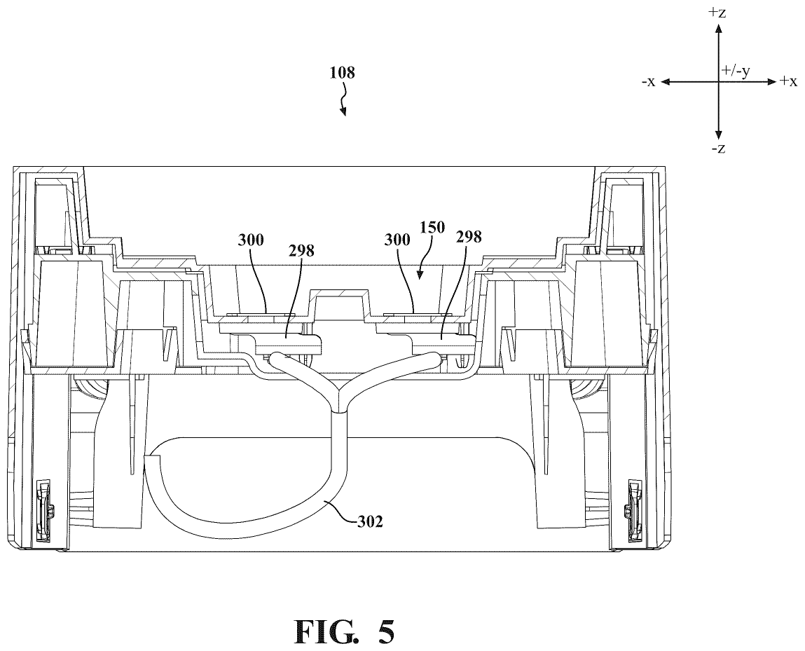

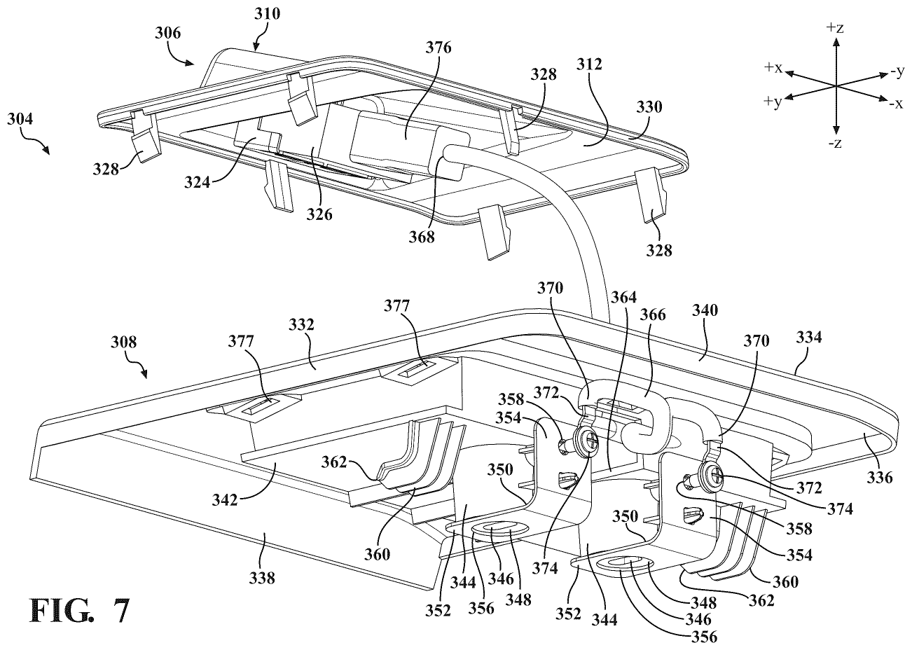

Referring now to FIG. 5, a cross-sectional front end view of the base unit 108 is illustrated to better depict a pair of transmitting brackets 298 shown extending through the base housing 120 such that an upper bracket portion 300 of the transmitting brackets 298 is received within the rear recessed portion 150 (FIG. 3). In embodiments, a wire 302 extends from a power source (not shown), such as a battery of the vehicle or the like, and splits to connect to each of the transmitting brackets 298 via welding, a fastener, or the like. As described in more detail herein, an electrical connection assembly 304 (FIG. 7) or the storage unit 110 (FIG. 8) may be electrically coupled to the wire 302.

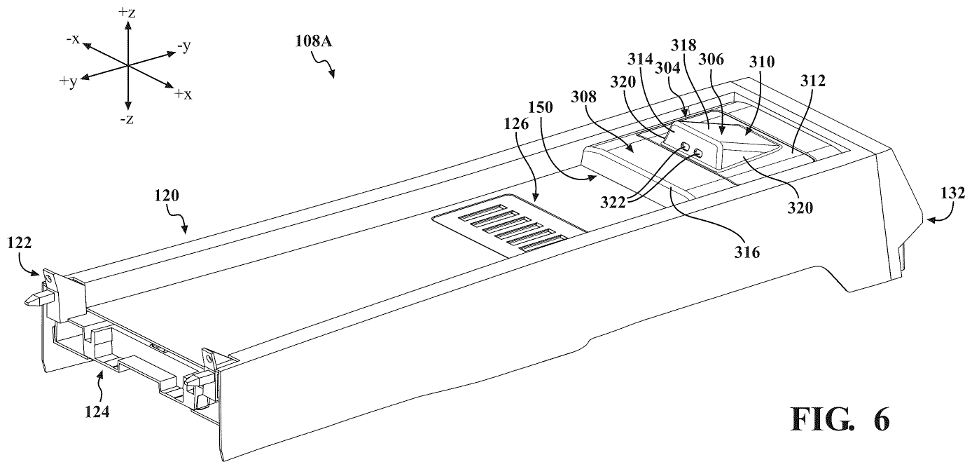

Referring now to FIG. 6, another embodiment of a base unit 108A is depicted. It should be appreciated that the base unit 108A includes similar structure to the base unit 108 illustrated in FIG. 2. Therefore, like reference numbers will be used to refer to like parts. Accordingly, the base unit 108A includes the base housing 120, the upper guide member 122, the lower guide member 124, the front recess cover 126, and the base register 132. The primary difference between the base unit 108 of FIG. 2 and the base unit 108A of FIG. 6 is that the base unit 108A does not include the rear recess cover 128 and instead includes the electrical connection assembly 304 provided within the rear recessed portion 150 for delivering power to an external electronic device such as, for example, a mobile phone, tablet, laptop, or the like.

It should be appreciated that the base unit 108A may be utilized as a standalone component without being coupled to the storage unit 110 (FIG. 8). As a standalone component, the electrical connection assembly 304 of the base unit 108A is utilized to provide power to external mobile devices, as described in more detail herein.

As shown in FIG. 6, the base unit 108A includes the electrical connection assembly 304 provided on and within the rear recessed portion 150 formed in the base housing 120. The electrical connection assembly 304 includes a port cover 306 and a connection cover 308. A protrusion 310 of the port cover 306 extends from a port wall 312 of the port cover 306 to be accessible from an exterior of the base unit 108A.

The protrusion 310 includes a front wall 314 extending from the port wall 312 proximate a front end 316 of the connection cover 308, an upper wall 318 extending from an end of the front wall 314, and a pair of side walls 320 extending between the front wall 314, the upper wall 318, and the port wall 312 of the port cover 306. The upper wall 318 slopes from the front wall 314 in a direction toward the port wall 312. One or more openings 322 are formed in a front wall 314 of the protrusion 310. As shown, a pair of openings 322 are formed in the front wall 314 of the protrusion 310 to permit a pair of electrical connections to be utilized.

Referring now to FIG. 7, the port cover 306 is shown disengaged from the connection cover 308. In embodiments, the protrusion 310 includes a holding member 324 provided within an interior of the protrusion 310. A port unit 326 is received within the holding member 324 to be retained therein. The port unit 326 includes one or more connections for connecting an external electrical device. The connections may include any suitable electrical connection type such as, for example, USB-A, USB-C, auxiliary input, or a combination thereof.

The port cover 306 further includes a plurality of hooks 328 extending from an outer edge 330 of the port wall 312 in a direction opposite the protrusion 310. The hooks 328 are shown extending from each outer edge of the port wall 312. However, it should be appreciated that any number of hooks 328 may be utilized and provided at any suitable location of the port wall 312.

Referring still to FIG. 7, the connection cover 308 includes a connection wall 332 having an upper surface 334, a lower surface 336 opposite the upper surface 334, a front end 338, and a rear end 340 opposite the front end 338. A cavity 342 is recessed into the connection wall 332 in a direction opposite the upper surface 334 to deform a portion of the connection wall 332.

In embodiments, one or more support columns 344 extend from the lower surface 336 of the connection wall 332 below the cavity 342. As shown, a pair of support columns 344 are provided and a hole 346 in a lower end 348 of each support column 344.

A pair of receiving brackets 350 are shown extending below the lower end 348 of respective support columns 344. Each receiving bracket 350 has an L-shape defining a lower bracket portion 352 positioned below the lower end 348 of the respective support column 344 and an upper bracket portion 354 extending from the lower bracket portion 352 in a direction toward the connection wall 332. A lower hole 356 is formed in the lower bracket portion 352 and an upper hole 358 is formed in the upper bracket portion 354. With the receiving brackets 350 positioned below the respective support columns 344, the lower hole 356 formed in the lower bracket portion 352 is aligned with the hole 346 formed in the lower end 348 of the respective support column 344. The receiving brackets 350 are formed from an electrically conductive material such as, for example, aluminum, copper, brass, stainless steel, nickel, or the like.

In embodiments, one or more feet 360 extend from the lower surface 336 of the connection wall 332 at the cavity 342. As shown, a pair of feet 360 extend from the lower surface 336 of the connection wall 332 on opposite sides of the support columns 344. Each foot 360 includes a claw 362 extending in a direction toward the front end 338 of the connection wall 332.

As shown in FIG. 7, an opening 364 is formed in the cavity 342 proximate the rear end 340 of connection cover 308. A wire 366 extends from the protrusion 310 of the port cover 306, through the opening 364, and to each of the receiving brackets 350. In embodiments, the wire 366 includes a first end 368 and a pair of second ends 370 opposite the first end 368. The wire 366 splits in a Y-formation to form the pair of second ends 370. In other embodiments, the wire 366 does not split and includes only a single second end 370. The second ends 370 each include an eyelet connection 372 and a fastener 374, such as a screw, extending through a respective eyelet connection 372. The fasteners 374 extend through the upper hole 358 formed in the upper bracket portion 354 of a respective receiving bracket 350. In other embodiments, the second ends 370 of the wire 366 may be directed connected to the upper bracket portions 354 via welding or the like.

A connector terminal 376 is provided at the first end 368 of the wire 366. The connector terminal 376 is positioned within the interior the protrusion 310 and engages the port unit 326 retained within the holding member 324 to be retained within the protrusion 310. With the connector terminal 376 positioned within the protrusion 310, the connections align with the openings 322 (FIG. 6) formed in the front wall 314 of the protrusion 310 such that an electrical cable may connect one or more external electrical devices to the port unit 326 to receive electrical power.

In embodiments, a plurality of slots 377 extend through the upper surface 334 and the lower surface 336 of the connection wall 332 on outer sides of the cavity 342. Although only a pair of slots 377 are shown in FIG. 7, any number of slots 377 may be formed in the connection wall 332. The number and location of the slots 377 correspond to the hooks 328 of the port cover 306 described herein.

With the port cover 306 positioned over the connection cover 308, the hooks 328 of the port cover 306 engage the slots 377 of the connection cover 308. Although the port cover 306 is described herein as being coupled to the connection cover 308 by the hooks 328 engaging the slots 377, the port cover 306 may be coupled to the connection cover 308 in any suitable manner other than that disclosed herein.

With the connection cover 308 positioned within the rear recessed portion 150 of the base housing 120, as shown in FIG. 6, the claws 362 and the feet 360 of the connection cover 308 are received within respective receiving openings 170 formed in the rear recessed portion 150 of the base housing 120 (FIG. 3) and respective receiving openings 248 formed in the rear recessed portion 230 of the upper guide member 122 (FIG. 3).

Additionally, the connection cover 308 positioned within the rear recessed portion 150 of the base housing 120, as shown in FIG. 6, the lower bracket portion 352 of each receiving bracket 350 contacts the upper bracket portion 300 of the transmitting brackets 298 (FIG. 5) received within the rear recessed portion 150 of the base housing 120 to complete an electrical circuit and deliver power from the power source to the connector terminal 376.

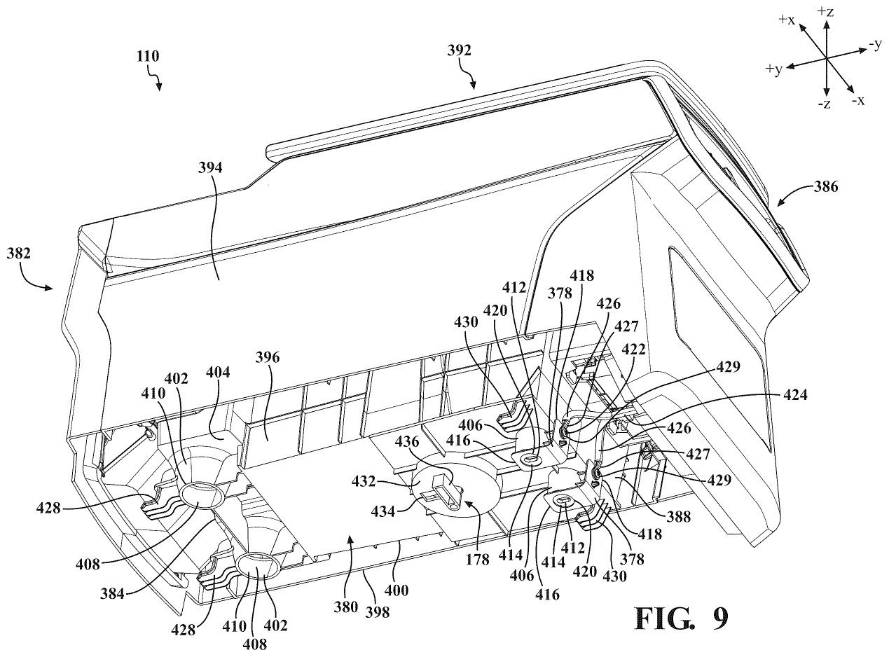

Referring now to FIGS. 8 and 9, the storage unit 110 is illustrated. The storage unit 110 illustrated in FIG. 8 is utilized in combination with the base unit 108 illustrated in FIG. 2, which does not include the electrical connection assembly 304. As described in more detail herein, the storage unit 110 includes a pair of receiving brackets 378 that contact the transmitting brackets 298 of the base unit 108 (FIG. 5) to electrically couple the storage unit 110 to the base unit 108.

The storage unit 110 includes a storage frame 380, a front end assembly 382 provided at a front end 384 of the storage frame 380, a rear end assembly 386 provided at a rear end 388 of the storage frame 380 opposite the front end assembly 382, a cup holder 390 provided within the storage frame 380 proximate the front end assembly 382, a lid 392 coupled to the storage frame 380, a first side panel 394 provided at a first side wall 396 of the storage frame 380, and a second side panel 398 provided at a second side wall 400 of the storage frame 380 opposite the first side panel 394.

As best shown in FIG. 9, in embodiments, one or more front support columns 402 extend from a lower wall 404 of the storage frame 380, and one or more rear support columns 406 extend from the lower wall 404 of the storage frame 380. As shown, a pair of front support columns 402 are provided proximate the front end 384 of the storage frame 380, and a pair of rear support columns 406 are provided proximate the rear end 388 of the storage frame 380. A hole 408 is provided in a lower end 410 of each of the front support columns 402, and a hole 412 is provided in a lower end 414 of each of the rear support columns 406.

As noted above, a pair of receiving brackets 378 are shown extending below the lower end 414 of respective rear support columns 406. The receiving brackets 378 of the storage unit 110 are similar in structure to the receiving brackets 350 of the electrical connection assembly 304 (FIG. 7) described herein. Accordingly, each receiving bracket 378 has an L-shape defining a lower bracket portion 416 positioned below the lower end 414 of the respective rear support column 406 and an upper bracket portion 418 extending from the lower bracket portion 416 in a direction toward the lid 392. A lower hole 420 is formed in the lower bracket portion 416 and an upper hole 422 is formed in the upper bracket portion 418. With the receiving brackets 378 positioned below the respective rear support columns 406, the lower hole 420 formed in the lower bracket portion 416 is aligned with the hole 412 formed in the lower end 414 of the respective rear support column 406. The receiving brackets 378 are formed from an electrically conductive material such as, for example, aluminum, copper, brass, stainless steel, nickel, or the like.

A wire 424 extends from each of the receiving brackets 378. The wire 424 splits in a Y-formation to form a pair of first ends 426. In other embodiments in which there is only a single receiving bracket 378, the wire 424 does not split and includes only a single first end 426. Similar to the electrical connection assembly 304 (FIG. 7), the first ends 426 may each include an eyelet connection 427 and a fastener 429, such as a screw, extending through a respective eyelet connection. The fasteners 429 extend through the upper hole 422 formed in the upper bracket portion 418 of a respective receiving bracket 378. In other embodiments, the first ends 426 of the wire 424 may be directed connected to the upper bracket portions 418 via welding or the like.

The storage frame 380 includes one or more front feet 428 provided at the front end 384 of the storage frame 380, and one or more rear feet 430 provided at the rear end 388 of the storage frame 380. In embodiments, the storage frame 380 includes a pair of front feet 428 extending from a respective front support column 402, and a pair of rear feet 430 provided on outer sides of the rear support columns 406. The front feet 428 and the rear feet 430 of the storage frame 380 are similar in structure to the feet 360 of the electrical connection assembly 304 (FIG. 7) described herein. The front feet 428 are configured to engage the floor pan 102 (FIG. 1), and the rear feet 430 are configured to engage the base unit 108 (FIG. 2), as described in more detail herein.

In embodiments, a dial receiver 432 extends from the lower wall 404 of the storage frame 380. The dial receiver 432 has a shape generally corresponding to a shape of the engagement wall 172 formed in the rear recessed portion 150 of the base housing 120 (FIG. 3) to be received therein. A dial slot 434 is formed in the dial receiver 432 and a lower portion 436 of the dial 178 extends therethrough.

Referring now to FIG. 10, a top view of the storage unit 110 is illustrated with the lid 392 removed to better illustrate internal components of the storage unit 110. The storage frame 380 includes an open interior 438 defined by the first side wall 396, the second side wall 400, the front end 384 (FIG. 8), the rear end 388 (FIG. 8), and the lower wall 404 (FIG. 8). As noted above, the storage unit 110 includes the cup holder 390 positioned within the open interior 438 of the storage frame 380 proximate the front end 384 of the storage frame 380. As shown in FIG. 10, the holes 412 formed in the rear support columns 406 and the dial receiver 432 is shown. Additionally, an upper portion 440 of the dial 178 is shown provided within the dial receiver 432. It should be appreciated that, with the storage unit 110 positioned on the base unit 108 (FIG. 2), the dial 178, specifically the lower portion 436 of the dial 178 (FIG. 9), is permitted to engage the slot 176 formed in the engagement wall 172 of the base housing 120 (FIG. 3) and the slot 244 formed in the engagement wall 242 of the upper guide member 122 (FIG. 3). Thus, as described in more detail herein, the dial 178 selectively locks the storage unit 110 to the base unit 108.

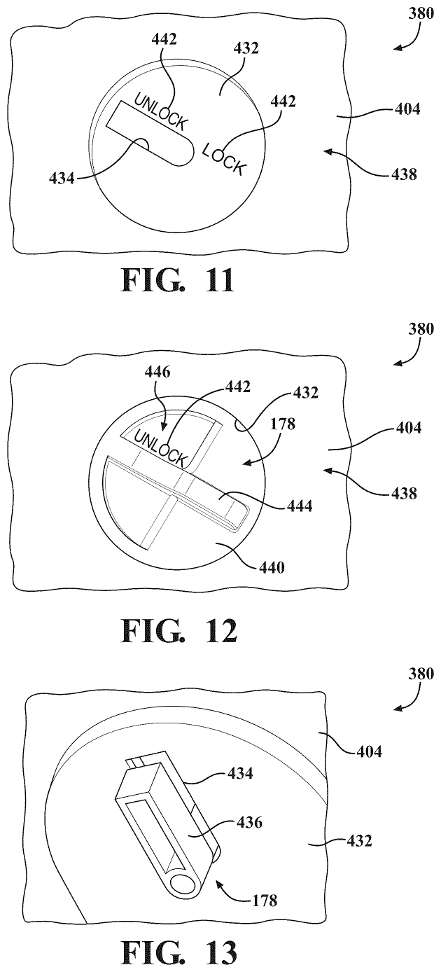

As shown in FIG. 11, the dial receiver 432 is shown from a view within the open interior 438 of the storage frame 380 without the dial 178 positioned therein. The dial slot 434 is formed in the dial receiver 432 offset from a center of the dial receiver 432. In embodiments, one or more indicia 442 may be printed on the dial receiver 432 within the open interior 438 of the storage frame 380 indicating an unlocked position and a locked position. The indicia 442 may be an icon, a color indicator, or printed text such as “unlock” and “lock”, as shown in FIG. 11.

As shown in FIG. 12, the dial 178 is positioned within the dial slot 434 and in the unlocked position. The upper portion 440 of the dial 178 defines an outer shape corresponding to the shape of the dial receiver 432, and includes a thumb tab 444 to facilitate manual rotation of the dial 178 within the dial receiver 432 by a user. Additionally, a window 446 is formed in the upper portion 440 of the dial 178 such that at least a portion of the indicia 442 on the dial receiver 432 remains visible based on the position of the dial 178. With the dial 178 positioned in the unlocked position, a first portion of the indicia 442, specifically “unlock”, is visible through the window 446 formed in the upper portion 440 of the dial 178.

As shown in FIG. 13, the lower portion 436 of the dial 178 is shown from a view below the storage frame 380 with the dial 178 still in the unlocked position. With the dial 178 in the unlocked position, the lower portion 436 of the dial 178 is aligned with the dial slot 434 formed in the dial receiver 432 such that the dial 178 may be removed from the dial receiver 432. As described herein, this permits the storage unit 110 to be removed from the base unit 108 (FIG. 2).

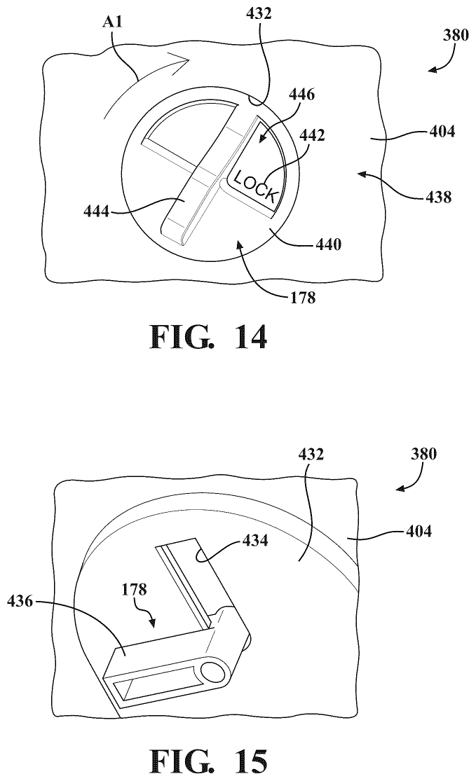

As shown in FIG. 14, the dial 178 is positioned within the dial slot 434 and rotated in the direction of arrow A1 to be in the locked position. With the dial 178 positioned in the locked position, a second portion of the indicia 442, specifically “lock”, is visible through the window 446 formed in the upper portion 440 of the dial 178.

As shown in FIG. 15, the lower portion 436 of the dial 178 is shown from a view below the storage frame 380 with the dial 178 still in the locked position. With the dial 178 in the locked position, the lower portion 436 of the dial 178 is out of alignment with the dial slot 434 formed in the dial receiver 432 such that the dial 178 may not be removed from the dial receiver 432. As described herein, this inhibits removal of the storage unit 110 from the base unit 108 (FIG. 2).

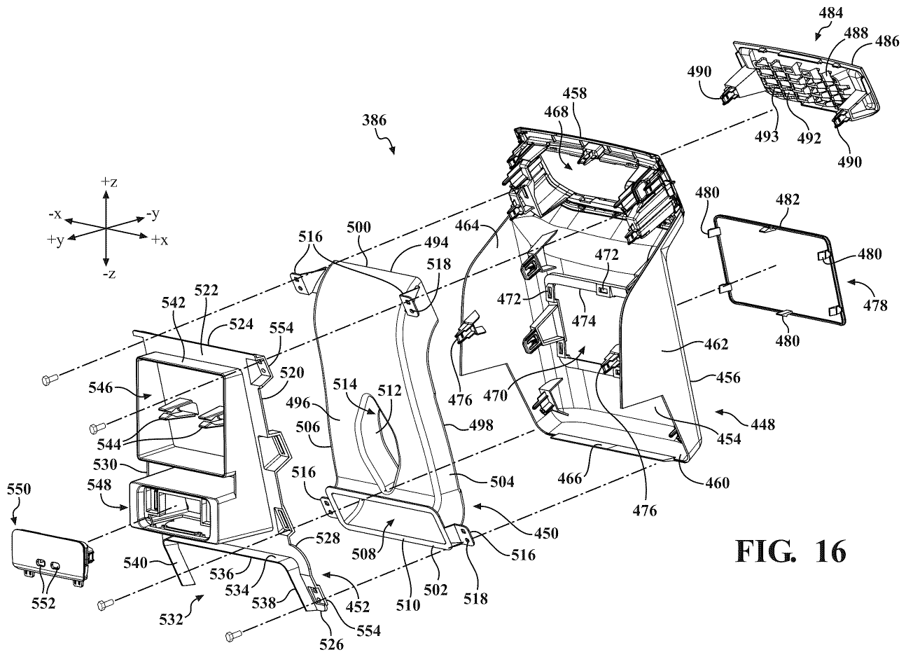

Referring now to FIG. 16, an exploded view of the rear end assembly 386 is shown. The rear end assembly 386 generally includes a rear end panel 448, a rear end duct 450 mounted to the rear end panel 448, and a rear end frame 452 mounted to the rear end duct 450 opposite the rear end panel 448.

The rear end panel 448 includes an inner surface 454, an outer surface 456 opposite the inner surface 454, an upper end 458, a lower wall 460 opposite the upper end 458 and extending in a direction opposite the outer surface 456, a first side wall 462 extending from the lower wall 460, and a second side wall 464 opposite the first side wall 462 extending from the lower wall 460. A tooth 466 is formed at an edge of the lower wall 460 extending in a direction opposite the outer surface 456. In embodiments, the tooth 466 is tapered such that a thickness of the tooth 466 decreases as the tooth 466 extends away from the lower wall 460. A register opening 468 is formed in the rear end panel 448 proximate the upper end 458. In embodiments, an electrical access window 470 is formed between the register opening 468 and the lower wall 460 of the rear end panel 448. One or more slots 472 may be formed along a perimeter 474 of the electrical access window 470.

The rear end panel 448 includes one or more fasteners 476, such as hooks, clips, or the like, for engaging the rear end duct 450 and/or the rear end frame 452. As shown, a plurality of fasteners 476 are shown extending from the inner surface 454 of the rear end panel 448 along the upper end 458, the first side wall 462, the second side wall 464, the register opening 468, and the electrical access window 470. However, it should be appreciated that any number of fasteners 476 may be provided at any suitable location on the inner surface 454 of the rear end panel 448.

In embodiments, a panel cover 478 may be provided over the electrical access window 470. The panel cover 478 may include one or more hooks 480 extending from an outer edge 482 of the panel cover 478. As shown, a plurality of hooks 480 are provided. The hooks 480 may engage the slots 472 formed along the perimeter 474 of the electrical access window 470 to secure the panel cover 478 onto the rear end panel 448 over the electrical access window 470. However, any suitable manner for attaching the panel cover 478 onto the rear end panel 448 may be contemplated.

An upper register 484 is positionable within the register opening 468 formed in the rear end panel 448. The upper register 484 includes an outer surface 486 and an inner surface 488 opposite the outer surface 486. In embodiments, one or more fasteners 490 extend from the inner surface 488 of the upper register 484 and engage the rear end panel 448 to secure the upper register 484 to the rear end panel 448. A plurality of apertures 492 are formed in the upper register 484 in any suitable arrangement. In embodiments, the apertures 492 are defined by fins 493. As shown in FIG. 16, the fins 493 are fixed. In other embodiments, the fins 494 are movable. With the upper register 484 positioned within the register opening 468 and the rear end panel 448 positioned against the rear end duct 450, air is permitted to flow out of an outlet 494 of the rear end duct 450 and through the apertures 492 formed in the upper register 484.

Referring still to FIG. 16, the rear end duct 450 includes an inner surface 496, an outer surface 498 opposite the inner surface 496, an upper end 500, a lower end 502 opposite the upper end 500, a first side wall 504, and a second side wall 506 opposite the first side wall 504. The first side wall 504 and the second side wall 506 each extend from the upper end 500 to the lower end 502 and between the outer surface 498 and the inner surface 496. A duct passageway 508 is defined by the outer surface 498, the inner surface 496, the first side wall 504, and the second side wall 506 to extend between the upper end 500 and the lower end 502. Accordingly, the lower end 502 defines an inlet 510, and the upper end 500 defines the outlet 494. As described herein, with the storage unit 110, specifically, the rear end assembly 386, mounted onto the base unit 108 (FIG. 2), air is directed into the duct passageway 508 through the lower end 502 and exits the duct passageway 508 at the upper end 500.

In embodiments, an inner wall 512 extends between the outer surface 498 and the inner surface 496 to define an electrical access void 514 aligned with the electrical access window 470 formed in the rear end panel 448. The electrical access void 514 may have any suitable shape. However, it is beneficial to reduce the size of the electrical access void 514 to avoid restricting flow of air through the duct passageway 508.

The rear end duct 450 includes one or more brackets 516 having holes 518 for engaging the rear end panel 448 and/or the rear end frame 452. As shown, a plurality of brackets 516 having holes 518 are shown extending from the first side wall 504 and the second side wall 506 at each of the upper end 500 and the lower end 502 to engage corresponding fasteners 476 of the rear end panel 448. However, it should be appreciated that any number of brackets 516 may be provided at any suitable location on the inner surface 496 of the rear end duct 450. In other embodiments, the rear end duct 450 may include fasteners, such as hooks, clips, or the like, for engaging the rear end panel 448 and/or the rear end frame 452 rather than the brackets 516 depicted herein.

Referring still to FIG. 16, the rear end frame 452 includes an outer surface 520, an inner surface 522 opposite the outer surface 520, an upper edge 524, a lower edge 526 opposite the upper edge 524, a first side edge 528, and a second side edge 530 opposite the first side edge 528. The first side edge 528 and the second side edge 530 extend between the upper edge 524 and the lower edge 526. A cutout 532 is formed in the lower edge 526 of the rear end frame 452. A lip 534 extends from the cutout 532 in a direction opposite the outer surface 520. The lip 534 includes an upper lip portion 536, a first side lip portion 538 extending from the upper lip portion 536, and a second side lip portion 540 extending from the upper lip portion 536 opposite the first side lip portion 538. With the rear end frame 452 positioned against the rear end duct 450, the cutout 532 aligns with the lower end 502 of the rear end duct 450 to allow for air to flow into the rear end duct 450.

In embodiments, the rear end frame 452 includes a cord containment wall 542 extending from the inner surface 522 and one or more cord clamps 544 are provided within a cord containment region 546 defined by the cord containment wall 542. As shown, a pair of cord clamps 544 are provided. The cord clamps 544 may be accessible from the open interior 438 of the storage frame 380 (FIG. 10) and suitable for securing a cord within the open interior 438.

In embodiments, an electrical access receiver 548 is formed in the rear end frame 452 below the cord containment wall 542. With the rear end frame 452 positioned against the rear end duct 450 and coupled to the rear end panel 448, the electrical access receiver 548 aligns with the electrical access void 514 of the rear end duct 450 and the electrical access window 470 of the rear end panel 448. In such embodiments, an electrical access cover 550 including one or more openings 552 formed therein may be positioned on the electrical access receiver 548.

The rear end frame 452 includes one or more brackets 554 or, in other embodiments, clips, hooks, or the like, for engaging the rear end duct 450 and/or the rear end panel 448. As shown, a plurality of brackets 554 are shown formed on the first side edge 528 and the second side edge 530 corresponding to the brackets 516 of the rear end duct 450. However, it should be appreciated that any number of brackets 554 may be provided at any suitable location of the rear end panel 448. As shown, a plurality of threaded fasters extend through the brackets 554 formed in the rear end frame 452 and the brackets 516 formed in the rear end duct 450 to secure the rear end frame 452 and the rear end duct 450 to one another.

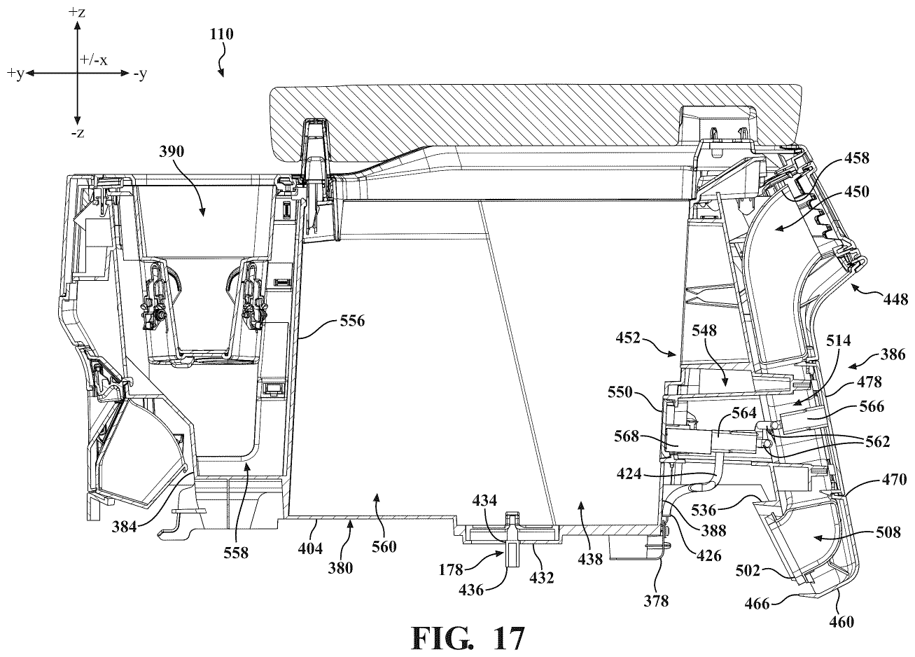

Referring now to FIG. 17, a cross-sectional side view of the storage unit 110 is illustrated. As shown, the storage frame 380 may include a dividing wall 556 separating the open interior 438 into a front interior portion 558 proximate the front end 384 of the storage frame and a rear interior portion 560 proximate the rear end 388 of the storage frame 380. The cup holder 390 may be positioned within the front interior portion 558 of the storage frame 380. Additionally, as shown, the dial 178 is shown provided within the dial receiver 432 formed in the lower wall 404 of the storage frame 380 such that the lower portion 436 of the dial 178 extends through the dial slot 434 formed in the dial receiver 432.

As described herein and as shown in FIG. 9, the storage unit 110 includes the wire 424 extending from each of the pair of receiving brackets 378. As shown in FIG. 17, the wire 424 extends from the receiving brackets 378 at the first ends 426, into the electrical access receiver 548 of the rear end frame 452, and splits to define a pair of second ends 562 opposite the first ends 426. A first connector terminal 564 is provided at one of the second ends 562 and a second connector terminal 566 is provided at the other of the second ends 562. The first connector terminal 564 connects to a port unit 568 positioned within the electrical access receiver 548 of the rear end frame 452, which abuts against the electrical access cover 550. Accordingly, an external electronic device positioned within the open interior 438 of the storage frame 380 may be connected to the first connector terminal 564. The second connector terminal 566 extends through the electrical access void 514 formed in the rear end duct 450 and abuts against the panel cover 478. With the panel cover 478 positioned over the electrical access window 470, access to the second connector terminal 566 is inhibited. However, embodiments are described herein in which the second connector terminal 566 is utilized.

Referring still to FIG. 17, the lower end 502 of the rear end duct 450 is shown positioned between the tooth 466 at the lower wall 460 of the rear end panel 448 and the upper lip portion 536 of the rear end frame 452. As described herein, the duct passageway 508 extends from the lower end 502 of the rear end duct 450 to the upper end 458 of the rear end duct 450 and is formed around the electrical access void 514 to permit the wire 424 to extend therethrough without inhibiting the flow of air.

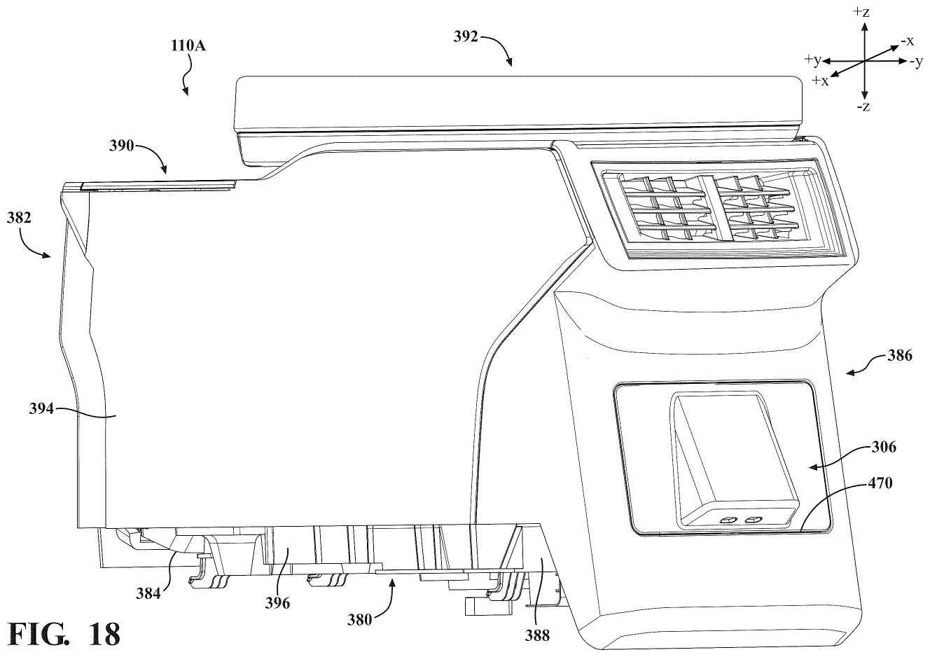

Referring now to FIG. 18, another embodiment of a storage unit 110A is depicted. The storage unit 110A illustrated in FIG. 8 is utilized in combination with the base unit 108 illustrated in FIG. 2, which does not include the electrical connection assembly 304.

It should be appreciated that the storage unit 110A includes similar structure to the storage unit 110 illustrated in FIG. 8. Therefore, like reference numbers will be used to refer to like parts. Accordingly, the storage unit 110A includes the storage frame 380, the front end assembly 382 provided at the front end 384 of the storage frame 380, the rear end assembly 386 provided at the rear end 388 of the storage frame 380 opposite the front end assembly 382, the cup holder 390 provided within the storage frame 380 proximate the front end assembly 382, the lid 392 coupled to the storage frame 380, the first side panel 394 provided at the first side wall 396 of the storage frame 380, and, although not depicted in FIG. 18, the second side panel 398 (FIG. 9) provided at the second side wall 400 of the storage frame 380 opposite the first side panel 394.

The primary difference between the storage unit 110A of FIG. 18 and the storage unit 110 of FIG. 8 is that the storage unit 110A of FIG. 18 does not include the panel cover 478 (FIG. 16) and instead includes the port cover 306 of the electrical connection assembly 304 described herein and illustrated in FIG. 7. The port cover 306 is provided within the electrical access window 470 formed in the rear end assembly 386 for delivering power to an external electronic device such as, for example, a mobile phone, tablet, laptop, or the like.

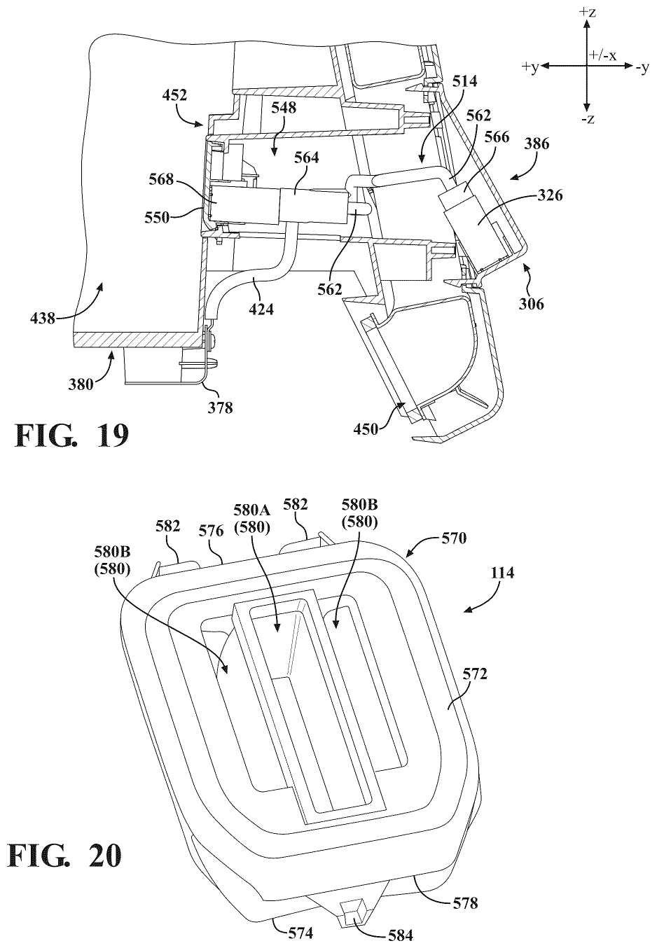

Referring now to FIG. 19, a partial cross-sectional side view of the rear end assembly 386 is illustrated. As shown, the wire 424 extends from the receiving brackets 378 and splits to form the pair of second ends 562 opposite the receiving brackets 378.

As described herein with respect to the storage unit 110 illustrated in FIG. 17, the first connector terminal 564 is provided at one of the second ends 562 and the second connector terminal 566 is provided at the other of the second ends 562. The first connector terminal 564 connects to the port unit 568 positioned within the electrical access receiver 548 of the rear end frame 452 and abuts against the electrical access cover 550. Accordingly, an external electronic device positioned within the open interior 438 of the storage frame 380 may be connected to the first connector terminal 564. The second connector terminal 566 extends through the electrical access void 514 formed in the rear end duct 450 and connects to the port unit 326 of the port cover 306. Accordingly, an external electronic device positioned outside of the storage unit 110A may be connected to the second connector terminal 566.

Referring now to FIG. 20, a perspective view of the device holder 114 is depicted. The device holder 114 includes a holder body 570 having an upper surface 572, a lower surface 574 opposite the upper surface 572, a front end 576, and a rear end 578 opposite the front end 576. The holder body 570 includes one or more cavities 580. As shown, three cavities 580 are formed in the upper surface 572 of the holder body 570 extending toward the lower surface 574. Specifically, the cavities 580 includes a central cavity 580A and a pair of side cavities 580B provided on opposite sides of the central cavity 580A. As shown, the central cavity 580A has a length extending between the front end 576 and the rear end 578 of the holder body 570 greater than a length of the side cavities 580B. It should be appreciated that the cavities 580 may have any suitable size and shape other than that depicted herein. Additionally, the cavities 580 may be located at any suitable location of the holder body 570.

The cavities 580 may be utilized to hold any suitable object or device. For example, one or more of the cavities 580, such as the central cavity 580A, may be configured to receive an electronic device. In addition, in such embodiments, the central cavity 580A of the device holder 114 may be equipped with wired or wireless charging capabilities, such as an inductive coil, for charging the electronic device provided therein. In other embodiments, the side cavities 580B may be equipped with wired or wireless charging capabilities for charging the electronic device provided therein, while the central cavity 580A is not equipped with wired or wireless charging capabilities.

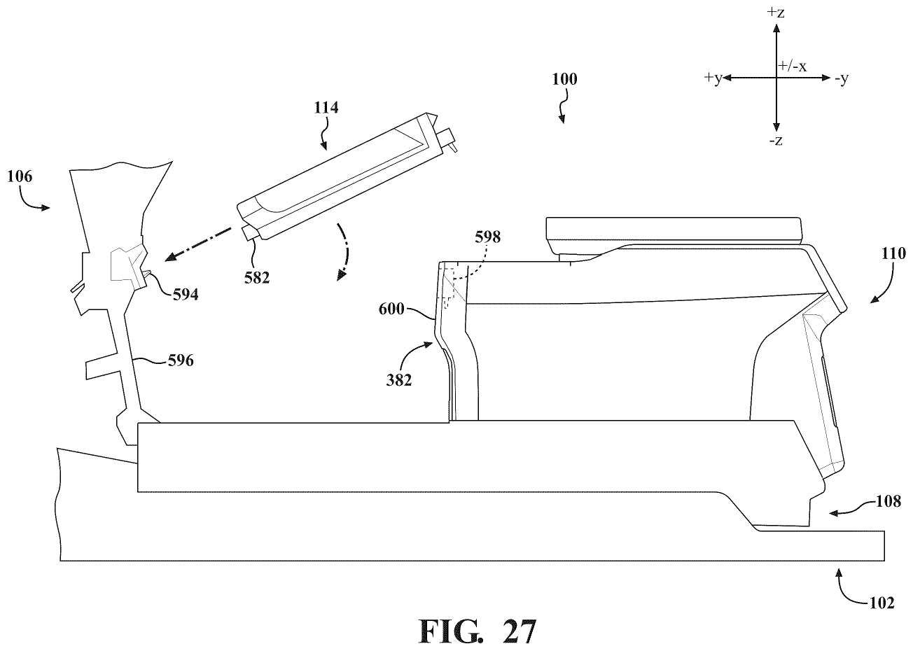

In embodiments, the device holder 114 includes one or more front engagement members 582 extending from the front end 576 of the holder body 570, and one or more rear engagement members 584 extending from the rear end 578 of the holder body 570 for attaching the device holder 114 to the upstanding support member 106 and the storage unit 110, as illustrated in FIG. 27 and described in more detail herein. As shown, the holder body 570 includes a pair of front engagement members 582 spaced apart from one another along the front end 576 of the holder body 570. Additionally, the holder body 570 includes one rear engagement member 584 extending from the rear end 578 of the holder body 570 at a substantially central portion of the rear end 578. However, the holder body 570 may include any number of front engagement members 582 and any number of rear engagement members 584 provided at any suitable location of the holder body 570.

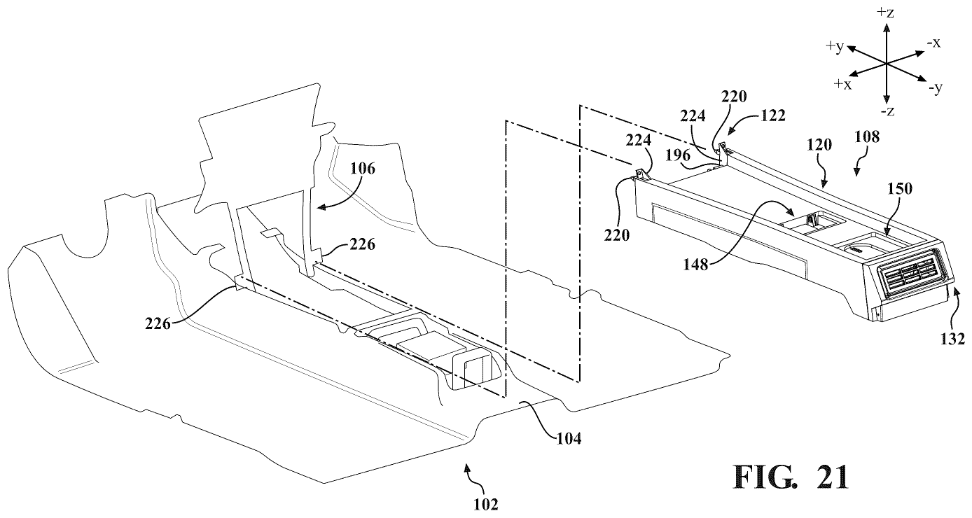

Referring now to FIG. 21, the base unit 108 of FIG. 2 is shown being installed onto the floor pan 102. Specifically, the base unit 108 is lowered onto the upper surface 104 of the floor pan 102 and moved in the +Y direction such that the pair of pins 220 extending from the front end 196 of the upper guide member 122 engage the pair of respective flanges 226 extending from opposite sides of the upstanding support member 106. Once the base unit 108 is in position on the floor pan 102, additional fasteners may be used to further secure the base unit 108 onto the floor pan 102. For example, fasteners, such as screws or the like, may be positioned within each of the holes 160, 168 (FIG. 3) formed in the front recessed portion 148 and the rear recessed portion 150 of the base housing 120 and engage a portion of the floor pan 102. After the base unit 108 is secured to the floor pan 102, the front recess cover 126 (FIG. 3) may be positioned over the front recessed portion 148, and the rear recess cover 128 (FIG. 3) may be positioned over the rear recessed portion 150. Although FIG. 21 depicts the manner in which the base unit 108 is attached to the floor pan 102, it should be appreciated that the base unit 108A of FIG. 6 may be installed onto the floor pan 102 in the same manner.

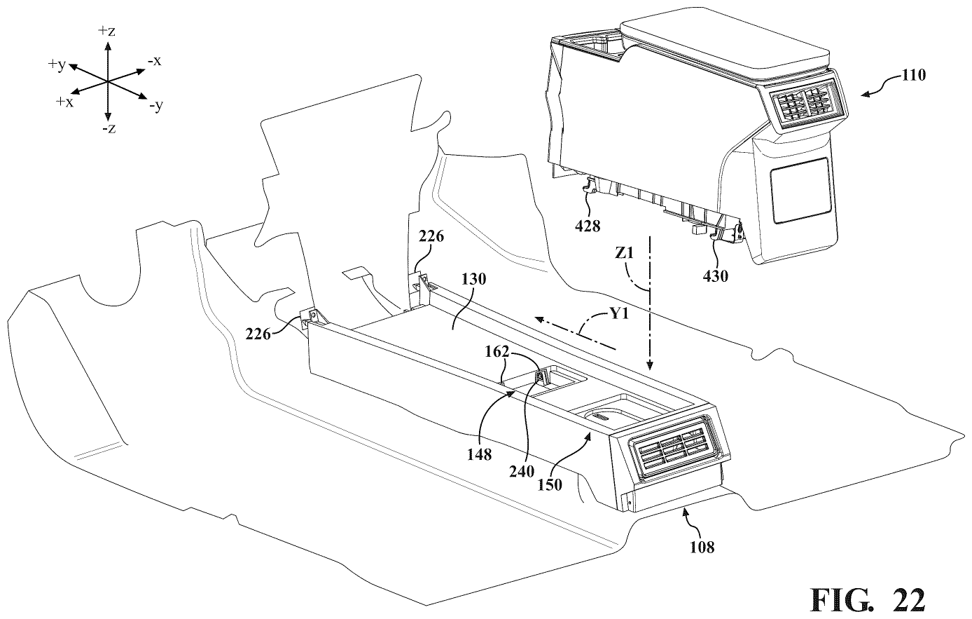

Referring now to FIG. 22, the storage unit 110 of FIG. 8 is shown being installed onto the base unit 108. Specifically, the storage unit 110 is lowered onto the upper wall 130 of the base housing 120 in the −Z direction as depicted by arrow Z1 such that the front feet 428 of the storage unit 110 are received within the front recessed portion 148. Thereafter, the storage unit 110 is moved in the +Y direction as depicted by arrow Y1 such that the front feet 428 of the storage unit 110 extend in a forward direction and are received within the receiving openings 162 formed in the front recessed portion 148 of the base housing 120 and the tunnels 240 formed in the front recessed portion 228 of the upper guide member 122 (FIG. 3). Additionally, the rear feet 430 of the storage unit 110 are received within the receiving openings 170 (FIG. 3) formed in the rear recessed portion 150 of the base housing 120 and the receiving openings 248 (FIG. 3) formed in the rear recessed portion 230 of the upper guide member 122. In other words, the storage unit 110 is installed onto the base unit 108 by initially moving the storage unit 110 in the −Z direction as depicted by arrow Z1 and subsequently moving the storage unit 110 in the +Y direction as depicted by arrow Y1. As described in more detail herein, one or more additional fasteners, such as screws or the like, may be used to further secure the storage unit 110 to the base unit 108. Although FIG. 22 depicts the manner in which the storage unit 110 is attached to the base unit 108, it should be appreciated that the storage unit 110A of FIG. 18 may be installed onto the base unit 108 in the same manner.

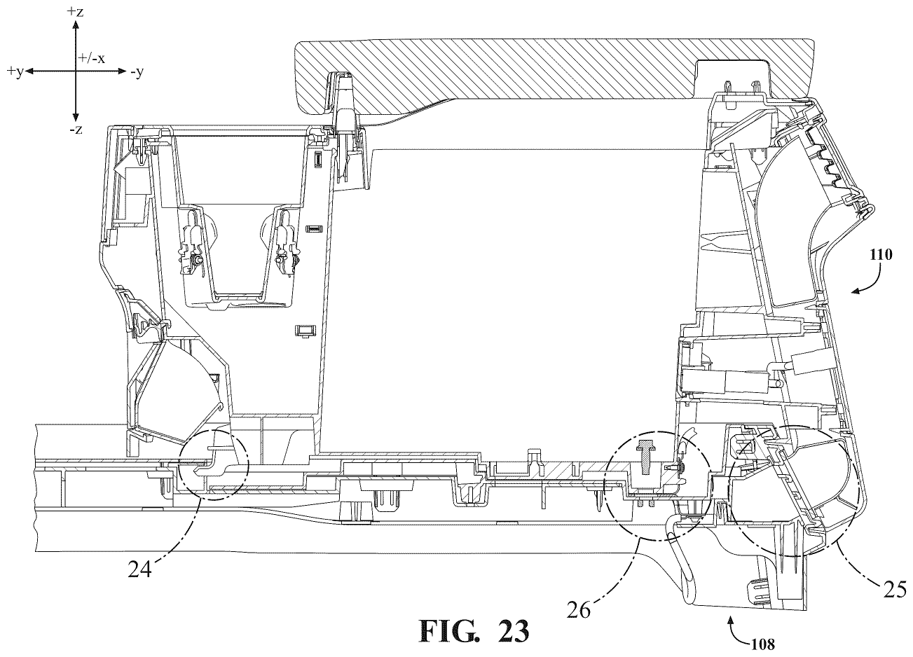

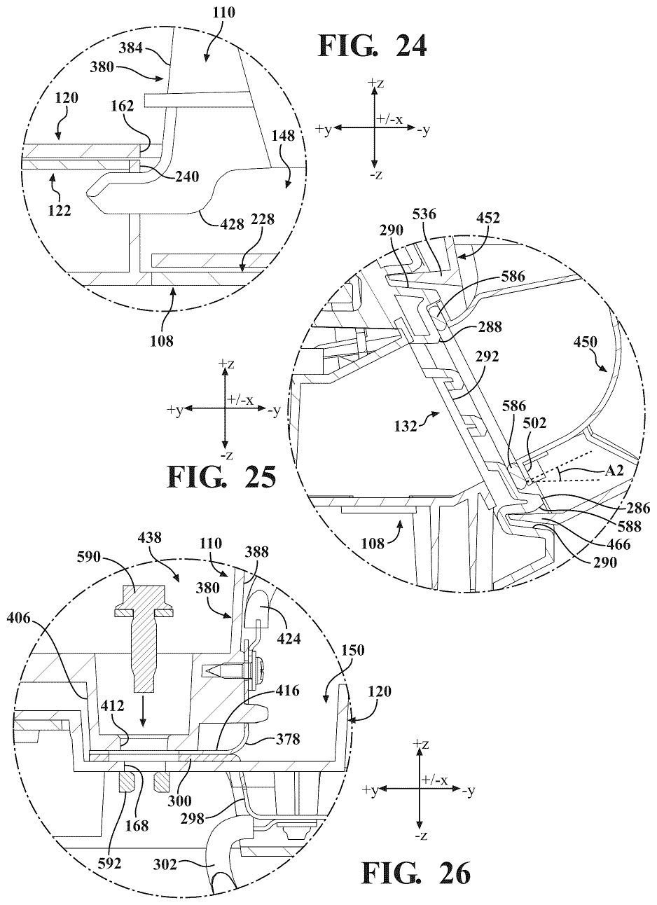

Referring now to FIG. 23, a cross-sectional side view of the storage unit 110 positioned on and engaged with the base unit 108 is illustrated. Specifically, with reference to FIG. 24, one of the front feet 428 of the storage unit 110 is shown extending through a respective receiving opening 162 formed in the front recessed portion 148 of the base housing 120 and a respective tunnel 240 formed in the front recessed portion 228 of the upper guide member 122. With the front feet 428 received within receiving openings 162 and the tunnels 240, the front end 384 of the storage frame 380 is inhibited from being lifted from the base unit 108 in the +Z direction. In practice, the storage unit 110 may be tilted such that the front end 384 of the storage frame 380 is lowered relative to the rear end 388 of the storage frame 380 (FIG. 8) to initially engage the front feet 428 with the base housing 120 and the upper guide member 122.

Thereafter, the rear end 388 of the storage frame 380 may be lowered to permit the lower end 502 of the rear end duct 450 to engage the base register 132 of the base unit 108, as shown in FIG. 25. This allows air flowing from the base register 132 to be directed to the upper register 484 through the rear end duct 450. Specifically, as shown, the lower end 502 of the rear end duct 450 is brought into position relative to the base register 132 of the base unit 108 such that the lower end 502 of the rear end duct 450 abuts against the contact surface 288 of the base register 132 of the base unit 108. In embodiments, as shown, a sealing member 586 is provided on the contact surface 288 of the base register 132 encircling the slots 292 formed in the base register 132. The sealing member 586 forms an airtight seal with the lower end 502 of the rear end duct 450.

Additionally, as shown in FIG. 25, the upper lip portion 536 of the rear end frame 452 is received within the groove 290 formed in the base register 132 above the contact surface 288, and the tooth 466 of the rear end duct 450 is received within the groove 290 formed in the base register 132 below the contact surface 288. Accordingly, the upper lip portion 536 and the tooth 466 retain the lower end 502 of the rear end duct 450 against the base register 132 of the base unit 108.

In embodiments, the lip 286 of the register has a chamfer 588 formed on an outer surface thereof facing the groove 290. As shown in FIG. 25, the chamfer 588 is oriented at an angle A2 relative to the outer surface of the lip 286. In embodiments, the angle A2 of the chamfer 588 is less than or equal to 20 degrees and equal to or greater than 50 degrees. In embodiments, the angle A2 of the chamfer 588 is less than or equal to 30 degrees and equal to or greater than 40 degrees. In embodiments, the angle A2 of the chamfer 588 is 35+/−30 %. In embodiments, the angle A2 of the chamfer 588 is 35+/−20 %. In embodiments, the angle A2 of the chamfer 588 is 35+/−10 %.

Referring now to FIG. 26, one of the rear support columns 406 of the storage unit 110 is shown positioned within a respective rear recessed portion 150 of the base housing 120. With the rear support column 406 positioned within the rear recessed portion 150, the lower bracket portion 416 of the receiving bracket 378 is positioned on and in contact with the upper bracket portion 300 of the transmitting bracket 298 of the base unit 108 extending within the rear recessed portion 150. Thus, an electrical circuit is completed between the wire 302 of the base unit 108 and the wire 424 of the storage unit 110. Thereafter, a fastener 590 is positioned within the rear recessed portion 150 and extends through the hole 412 formed in the rear support column 406 and the hole 168 formed in the rear recessed portion 150. Additionally, the fastener 590 extends through the lower bracket portion 416 of the receiving bracket 378 and the upper bracket portion 300 of the transmitting bracket 298 to ensure the receiving bracket 378 and the transmitting bracket 298 remain in contact with one another. In embodiments, a nut 592 may be provided on an underside of the rear recessed portion 150 to retain the fastener 590 in position.

Referring now to FIG. 27, a side view of the center console assembly 100 is depicted with the base unit 108 provided on the floor pan 102 and the storage unit 110 provided on the base unit 108. Additionally, the device holder 114 is shown being positioned on the center console assembly 100. Specifically, the front engagement member 582 initially engages a tab 594 formed on a rear surface 596 of the upstanding support member 106 extending from the floor pan 102. Once the front engagement member 582 engages the tab 594 on the upstanding support member 106, the rear end 578 of the device holder 114 is lowered such that the rear engagement member 584 engages a cutout 598 formed in the front end assembly 382 of the storage unit 110. In embodiments, the front end assembly 382 of the storage unit 110 includes a front end cover 600 positioned over the cutout 598 to conceal the cutout 598 when the device holder 114 is not utilized. Although the device holder 114 is shown engaging the storage unit 110, it should be appreciated that the device holder 114 may similarly engage the storage unit 110A of FIG. 18 in the same manner.

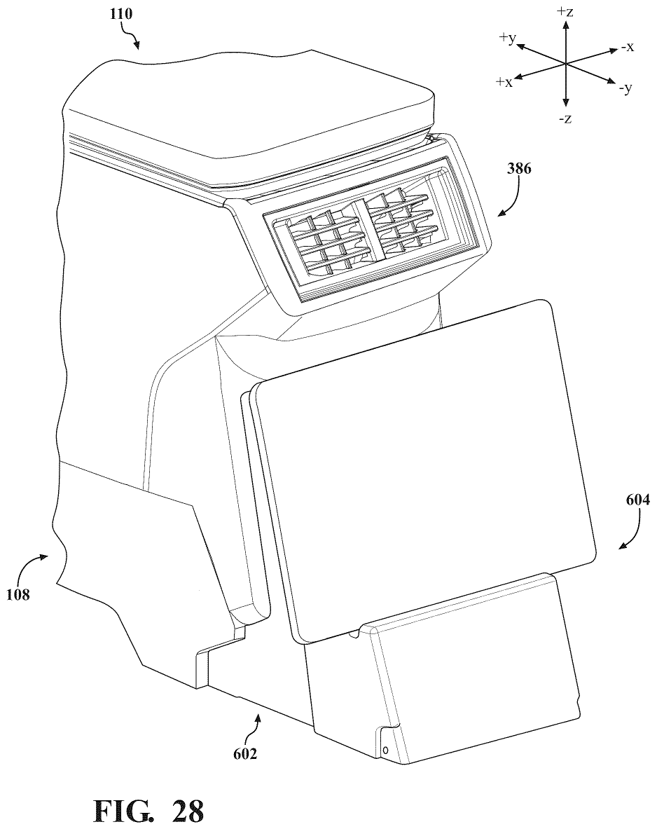

Referring now to FIG. 28, a partial rear perspective view of the storage unit 110 of FIG. 8 is depicted with an accessory mounting plate 602 and a tablet station 604 mounted to the rear end assembly 386 of the storage unit 110 and the base register 132 of the base unit 108 (FIG. 3). As described in more detail herein, the tablet station 604 may be utilized to support a mobile device, such as a tablet, laptop, phone, or the like, and, in embodiments, include wired or wireless charging capabilities to the mobile device.

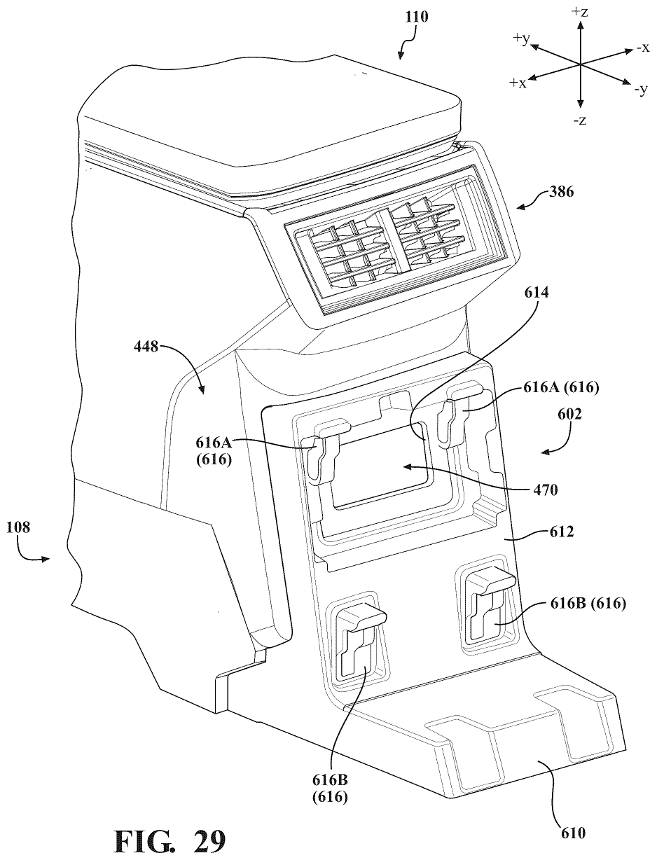

Referring now to FIG. 29, the accessory mounting plate 602 is shown mounted onto the rear end assembly 386 of the storage unit 110 and the base register 132 of the base unit 108 (FIG. 3) with the tablet station 604 removed. In embodiments, the accessory mounting plate 602 is mounted onto the base register 132 of the base unit 108 using one or more fasteners. In other embodiments, the accessory mounting plate 602 is mounted onto the rear end assembly 386, and specifically the rear end panel 448, using one or more fasteners. In other embodiments, the accessory mounting plate 602 is mounted onto the base register 132 of the base unit 108 and the rear end assembly 386 of the storage unit 110. However, it should be appreciated that the accessory mounting plate 602 may be attached to the base unit 108 and/or the storage unit 110 in any suitable manner.

As shown, the accessory mounting plate 602 includes a lower wall 610 and a contact wall 612 that extends from the lower wall 610 and along the rear end panel 448 of the rear end assembly 386. A window 614 is formed in the contact wall 612 that aligns with the electrical access window 470 formed in the rear end panel 448 when the accessory mounting plate 602 is positioned against the rear end panel 448. In embodiments, the accessory mounting plate 602 has a plurality of receiving openings 616 formed in the contact wall 612. As shown, a pair of upper receiving openings 616A are formed on opposite sides of the window 614, and a pair of lower receiving openings 616B are formed between the window 614 and the lower wall 610. However, the number and location of the receiving openings 616 can vary other than that depicted herein.

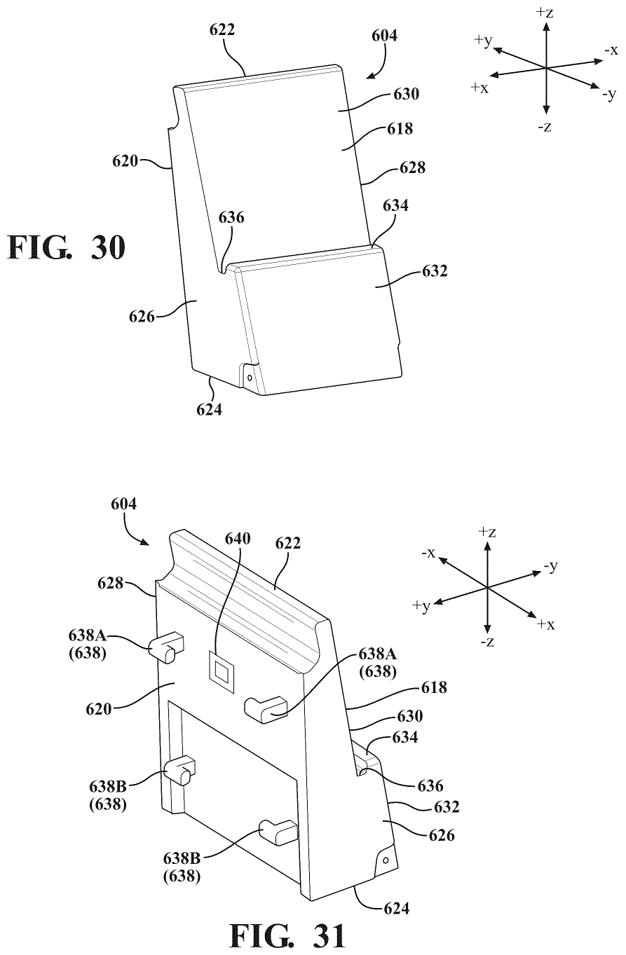

Referring now to FIGS. 30 and 31, the tablet station 604 is depicted. The tablet station 604 includes a contact surface 618, a support surface 620 opposite the contact surface 618, an upper end 622, a lower end 624 opposite the upper end 622, a first side surface 626 extending between the contact surface 618 and the support surface 620, and a second side surface 628 opposite the first side surface 626 extending between the contact surface 618 and the support surface 620. The support surface 620 is oriented at an acute angle relative to the contact surface 618. Specifically, a width of each of the first side surface 626 and the second side surface 628 extending between the contact surface 618 and the support surface 620 is greater proximate the upper end 622 of the tablet station 604 compared to the width of each of the first side surface 626 and the second side surface 628 proximate the lower end 624 of the tablet station 604.

As shown in FIG. 30, the support surface 620 of the tablet station 604 includes an upper support surface portion 630 and a lower support surface portion 632. The lower support surface portion 632 is spaced further from the contact surface 618 than the upper support surface portion 630 and defines an abutment 634. The abutment 634 further defines a channel 636 extending between the first side surface 626 and the second side surface 628. Accordingly, a mobile device, such as a tablet, laptop, phone, or the like, may be seated within the channel 636 and rest against the abutment 634 and the upper support surface portion 630.

Referring again to FIG. 31, the tablet station 604 includes one or more hooks 638 extending from the contact surface 618 in a direction opposite the support surface 620. As shown, the tablet station 604 includes a pair of upper hooks 638A proximate the upper end 622 of the tablet station 604, and a pair of lower hooks 638B proximate the lower end 624 of the tablet station 604. The hooks 638 are configured to engage the receiving openings 616 formed in the accessory mounting plate 602 (FIG. 29). Specifically, the upper hooks 638A are configured to engage the upper receiving openings 616A formed in the accessory mounting plate 602, and the lower hooks 638B are configured to engage the lower receiving openings 616B formed in the accessory mounting plate 602.

Additionally, a port unit 640 is formed in the contact surface 618 of the tablet station 604 to permit the tablet station 604 to be electrically coupled to the second connector terminal 566 of the storage unit 110, as shown in FIG. 17, when the panel cover 478 is removed. The port unit 640 may be electrically coupled to a wireless charging device, such as an inductive coil or the like, or to a wired connector. In either embodiment, a mobile device provided on the tablet station 604 may receive power from the port unit 640 by being communicatively coupled with the wireless charging device or the wired connector.

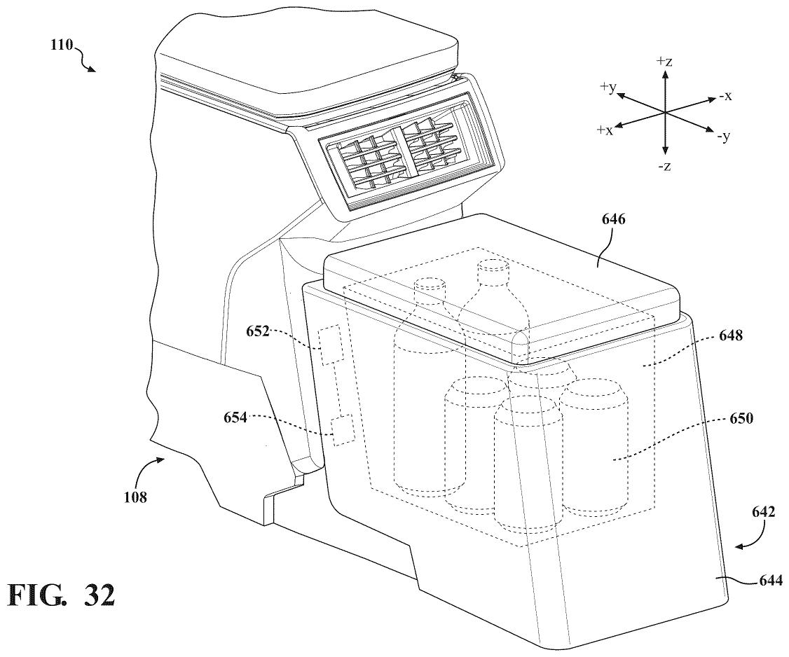

Referring now to FIG. 32, a partial rear perspective view of the base unit 108 and the storage unit 110 is depicted with a cooler 642 mounted to the accessory mounting plate 602. The cooler 642 includes a cooler body 644 and a cooler lid 646 removably attached to the cooler body 644. The cooler body 644 defines an open interior 648 in which contents 650 may be placed to be kept cold. Although not depicted, the cooler body 644 may include one or more hooks for engaging the accessory mounting plate 602 as described herein with respect to the tablet station 604 (FIG. 31).

Additionally, a port unit 652 is formed in the cooler body 644 of the cooler 642 to permit the cooler 642 to be electrically coupled to the second connector terminal 566 of the storage unit 110, as shown in FIG. 17, when the panel cover 478 is removed. The port unit 652 may be electrically coupled to a cooling element 654 for maintaining a temperature within the open interior 648 of the cooler body 644.

Although only the tablet station 604 and the cooler 642 are depicted herein as being mounted to the accessory mounting plate 602 and electrically coupled to the storage unit 110, it should be appreciated that other suitable accessories may be utilized and are within the scope of the present disclosure. For example, a heated cup holder for holding and maintaining a temperature of a warm drink, an audiovisual device, an air purifier, and the like may be mounted to the accessory mounting plate 602.

From the above, it is to be appreciated that defined herein are center console assemblies including a base unit including a base register, and a storage unit including a rear end assembly, the rear end assembly including an upper register, the rear end assembly mounted to the base register to removably attach the storage unit to the base unit. In embodiments, the rear end assembly includes a rear end duct having an inlet and an outlet opposite the inlet. The inlet of the rear end duct abuts against the base register and directs a flow of air from the base register to the outlet of the upper register.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A center console assembly comprising:
a base unit including a base register; and
a storage unit including a rear end assembly, the rear end assembly including an upper register, the rear end assembly mounted to the base register to removably attach the storage unit to the base unit.

2. The center console assembly of claim 1, wherein:
the base register includes a register wall, the register wall includes an outer register surface, a lip, and a contact surface defining a plurality of slots on a side of the lip opposite the outer register surface,
a groove is formed between the outer register surface and the lip, the groove circumscribes the lip.

3. The center console assembly of claim 2, wherein:
the rear end assembly comprises:
a rear end panel including a lower wall and a tooth extending from the lower wall;
a rear end duct; and
a rear end frame provided on a surface of the rear end duct opposite the rear end panel, the rear end frame including a lip;
the tooth of the rear end panel extends into the groove below the contact surface; and
the lip of the rear end frame extends into the groove above the contact surface.

4. The center console assembly of claim 3, wherein the groove defines a chamfer oriented at an angle relative to an outer surface of the lip of the base register.

5. The center console assembly of claim 4, wherein the angle is less than or equal to 20 degrees and equal to or greater than 50 degrees.

6. The center console assembly of claim 1, wherein:
the base unit includes a receiving opening; and
the storage unit includes a foot received within the receiving opening when the storage unit is mounted to the base unit.

7. The center console assembly of claim 6, wherein the foot of the storage unit is installed to extend in a forward direction through the receiving opening when the storage unit is mounted to the base unit.

8. The center console assembly of claim 1, wherein:
the base unit includes a base housing defining a front recessed portion and a rear recessed portion; and
the receiving opening of the base unit includes a pair of receiving openings formed in the front recessed portion and a pair of receiving openings formed in the rear recessed portion.

9. The center console assembly of claim 8, wherein:
the storage unit includes a pair of front feet and a pair of rear feet;
the pair of front feet are received within respective receiving openings within the front recessed portion of the base housing; and
the pair of rear feet are received within respective receiving openings within the rear recessed portion of the base housing.

10. The center console assembly of claim 1, wherein:
the base unit includes a dial slot;
the storage unit includes a dial receiver and a dial slot formed in the dial receiver, the dial slot of the storage unit aligns with the dial slot of the base unit; and
a dial is positionable within the dial receiver of the storage unit and partially extends through the dial slot of the base unit to selectively lock the storage unit to the base unit.

11. A center console assembly comprising:
a base unit including a base register; and
a storage unit mounted to the base unit, the storage unit including a rear end assembly, the rear end assembly including a rear end duct having an inlet and an outlet opposite the inlet, and an upper register,
wherein the inlet of the rear end duct abuts against the base register and directs a flow of air from the base register to the outlet of the upper register.

12. The center console assembly of claim 11, wherein:
the base register includes a register wall, the register wall includes an outer register surface, a lip, and a contact surface defining a pair of slots on a side of the lip opposite the outer register surface,
a groove is formed between the outer register surface and the lip, the groove circumscribes the lip.

13. The center console assembly of claim 12, wherein:
the rear end assembly comprises:
a rear end panel including a lower wall and a tooth extending from the lower wall; and
a rear end frame provided on a surface of the rear end duct opposite the rear end panel, the rear end frame including a lip;
the tooth of the rear end panel extends into the groove below the contact surface; and
the lip of the rear end frame extends into the groove above the contact surface.

14. The center console assembly of claim 13, wherein the groove defines a chamfer oriented at an angle relative to an outer surface of the lip of the base register.

15. The center console assembly of claim 14, wherein the angle is less than or equal to 20 degrees and equal to or greater than 50 degrees.

16. The center console assembly of claim 13, wherein a sealing member is provided on the contact surface of the base register to form a seal between the base register and the inlet of the rear end duct.

17. A method comprising:
positioning a base unit on a floor pan of a vehicle, the base unit including a base register;
securing the base unit to the floor pan;
positioning a storage unit on the base unit, the storage unit including a rear end assembly, the rear end assembly including an upper register; and
securing the storage unit to the base unit by engaging the rear end assembly with the base register.

18. The method of claim 17, wherein engaging the rear end assembly with the base register comprises:
inserting a tooth of a rear end panel of the rear end assembly into a groove formed in a register wall of the base register; and
inserting a lip of a rear end frame of the rear end assembly into the groove formed in the register wall of the base register above the tooth.

19. The method of claim 18, wherein the groove defines a chamfer oriented at an angle relative to an outer surface of a lip of the base register.

20. The method of claim 19, wherein the angle is less than or equal to 20 degrees and equal to or greater than 50 degrees.
